(19) United States
(12) Patent Application Publication
(10) Pub. No.: US 2021/0260909 A1
(43) Pub. Date: Aug. 26, 2021

(54) SECURITY DEVICES AND METHODS OF AUTHENTICATION THEREOF

(71) Applicant: DE LA RUE INTERNATIONAL LIMITED, Basingstoke, Hampshire (GB)

(72) Inventors: Brian William HOLMES, Hampshire (GB); Jonathan TONER, Basingstoke (GB)

(73) Assignee: DE LA RUE INTERNATIONAL LIMITED, Basingstoke, Hampshire (GB)

(21) Appl. No.: 17/262,831

(22) PCT Filed: Aug. 5, 2019
(86) PCT No.: PCT/GB2019/052188

§ 371 Date: Jan. 25, 2021

(30) Foreign Application Priority Data
Aug. 10, 2018 (GB) 1813133.4

(51) Int. Cl. B42D 25/378; C09D 11/50; B41M 3/14

(52) U.S. Cl. CPC B42D 25/378; B82Y 20/00; B41M 3/144; C09D 11/50

(57) ABSTRACT

A security device includes a substrate and a photoluminescent image on or in the substrate. The image includes at least two different visible light emitting photoluminescent quantum dot compositions, each arranged according to different respective photoluminescent sub-images. The at least two different visible light emitting photoluminescent quantum dot compositions have different emission spectra from one another, and the same or different excitation spectra. The at least two different visible light emitting photoluminescent quantum dot compositions emit different respective visible colours from one another when excited. The respective photoluminescent sub-images are configured such that the photoluminescent image formed by the combination of the respective photoluminescent sub-images is multi-coloured, emitting different visible colours in different laterally offset parts thereof upon excitation of the at least two different visible light emitting photoluminescent quantum dot compositions. At least a portion of the photoluminescent image overlaps an at least semi-transparent region of the substrate.

This invention relates to security devices for authenticating articles of value including security documents such as banknotes, cheques, passports, identity cards, certificates of authenticity, fiscal stamps and other secure documents, as well as methods by which such security devices may be authenticated. Methods for manufacturing such security elements are also disclosed.

Articles of value, and particularly documents of value such as banknotes, cheques, passports, identification documents, certificates and licenses, are frequently the target of counterfeiters and persons wishing to make fraudulent copies thereof and/or changes to any data contained therein. Typically such objects are provided with a number of visible security devices for checking the authenticity of the object. By “security device” we mean a feature which it is not possible to reproduce accurately by taking a visible light copy, e.g. through the use of standardly available photocopying or scanning equipment. Examples include features based on one or more patterns such as microtext, fine line patterns, latent images, venetian blind devices, lenticular devices, moiré interference devices and moiré magnification devices, each of which generates a secure visual effect. Other known security devices include holograms, watermarks, embossings, perforations and the use of colour-shifting or luminescent/fluorescent inks. Common to all such devices is that the visual effect exhibited by the device is extremely difficult, or impossible, to copy using available reproduction techniques such as photocopying. Security devices exhibiting non-visible effects such as magnetic materials may also be employed.

One known class of security device are those which make use of luminescent substances (which term includes materials having fluorescent or phosphorescent properties). Such materials respond visibly to irradiation at certain wavelengths (often outside the visible spectrum), typically by emitting light of a particular colour characteristic of the material in question. The presence of such materials is therefore not readily detectable in normal illumination circumstances where the security device is illuminated with visible light only, but can be tested for by illuminating the security device with light of the appropriate wavelength, e.g. ultra-violet.

Luminescent security features of this sort therefore provide a distinctive, high visual impact effect which is memorable and easily identified. However, luminescent inks are becoming more readily available on the commercial market and hence are accessible to would-be counterfeiters. Further, it can be inconvenient to require a specific source of non-visible light, such as UV, in order to perform authentication.

As such, more complex luminescent features are needed to make counterfeiting more difficult and hence increase the security level. At the same time, features which are more readily testable without special sources of non-visible light would be welcomed.

US-A-2004/0233465 discloses providing an article with an image for authentication thereof, comprising a plurality of inks having a plurality of fluorescent colours when exposed to excitation energy. The resulting image therefore appears in multiple colours when excited. In some embodiments, the luminescent substances which provide the inks with their fluorescent colours are quantum dots, which offer a number of advantages over other luminescent substances. In particular, quantum dots can have a much smaller Stokes' shift (the difference between the wavelength(s) which excites the material and those at which it emits) than conventional luminescent materials, meaning that many can be activated by visible light or light at the edge of the visible spectrum (e.g. near IR, or deep blue light). Such wavelengths are frequently included in the light emitted by common light sources such as torches and thereby enable the device to be authenticated using readily available equipment rather than specialist tools.

Nonetheless, improved security effects are constantly being sought in order to stay ahead of counterfeiters.

In accordance with a first aspect of the invention, a security device is provided, comprising:

a substrate; and

a photoluminescent image disposed on or in the substrate, the photoluminescent image comprising at least two different visible light emitting photoluminescent quantum dot compositions, each arranged according to different respective photoluminescent sub-images, the at least two different visible light emitting photoluminescent quantum dot compositions having different emission spectra from one another, and the same or different excitation spectra, the at least two different visible light emitting photoluminescent quantum dot compositions thereby emitting different respective visible colours from one another when excited;

wherein the respective photoluminescent sub-images are configured such that the photoluminescent image formed by the combination of the respective photoluminescent sub-images is multi-coloured, emitting different visible colours in different laterally offset parts thereof upon excitation of the at least two different visible light emitting photoluminescent quantum dot compositions.

wherein at least a portion of the photoluminescent image overlaps an at least semi-transparent region of the substrate.

By arranging the photoluminescent image to at least partially (preferably wholly) overlap a region of the substrate which is at least semi-transparent, various new visual effects can be achieved by virtue of the ability to illuminate the image in a transmissive (rather than reflective) mode—that is, placing the photoluminescent image between the viewer and the light source(s). This allows the security device to be positioned very close to (or even in contact with) the light source without obstructing the user's view of the device, which (for a given light source) increases the directionality and intensity of the light incident on the photoluminescent quantum dot compositions and correspondingly the intensity of the light emitted by those compositions, thereby resulting in a brighter and more visually striking photoluminescent image. By “at least semi-transparent”, we mean that the region of the substrate is able to transmit at least some wavelengths of light (particularly visible light) for instance the region may be translucent or transparent (clear) but not opaque. Most preferably, the region is transparent (clear) but not necessarily to all wavelengths of visible light. That is, it may carry a coloured tint, possibly in the form of an optical filter as discussed below. The at least semi-transparent region may comprise only a part of the substrate, or the whole substrate may be at-least semi-transparent.

A visible light emitting photoluminescent quantum dot composition is one which, when excited, emits light of which at least part is in the visible spectrum (e.g. at one or more wavelengths between about 380 to 780 nm). The emitted light may or may not also include one or more invisible wavelengths (e.g. infrared or ultraviolet). The composition may or may not be visible to the naked eye when not excited. The photoluminescent image may optionally also include one or more invisible light emitting photoluminescent quantum dot compositions, i.e. those which, when excited, emit only invisible wavelengths of light. If provided, these parts of the image would only be detectable by machine and would therefore not compromise the look of the visible image.

It should be noted that the various photoluminescent quantum dot compositions making up the photoluminescent image could be provided in the same or different planes as one another. For instance, all of the compositions may be located the same surface of the substrate, or one or more of the compositions could be provided on a first surface of the substrate and the remainder on the other surface. In still further examples, the substrate could be a multi-layered substrate (e.g. a laminate) and the respective compositions could be located at different layer interfaces within the substrate (optionally in addition to being on one or more of the outer surfaces). In all cases it should be noted that “on” does not require the composition to be “directly on” the said surface—there may be some intermediate layer or material between the two, such as a primer.

Each sub-image defines the (macro-scale) area(s) of the image which require a contribution from the colour in which the respective visible light emitting photoluminescent quantum dot composition emits when excited. As described below, within each sub-image, on a microscopic scale the compositions may be arranged according to pixels or screen elements. Thus in areas where two or more of the sub-images overlap, pixels or screen elements formed of each of the two or more respective visible light emitting photoluminescent quantum dot compositions will be present alongside one another. The colour of each overlapping area therefore appears to the naked human eye as that formed by additive colour mixing of the various emitted colours present in that overlapping area.

In practice, the at least two visible light emitting photoluminescent quantum dot compositions may be excited simultaneously or sequentially (if they have different excitation spectra), in order to visualise the desired image, as will be discussed further below. Either way, the arrangement of the respective sub-images is such that the device will have a multi-coloured appearance to the naked human eye when the at least two visible light emitting photoluminescent quantum dot compositions are excited simultaneously—that is, different locations of the device will appear with a different colour from one another, on a scale which is visible without magnification. One or more non-luminescent inks could also be provided and contribute to the image if desired.

Whilst the at least two visible light emitting photoluminescent quantum dot compositions could occupy the whole of the at least semi-transparent region, it is preferred that at least a portion of the at least semi-transparent region is not overlapped by a visible light emitting photoluminescent QD composition. This non-luminescent portion (or part of it) may contribute directly to the image, as described further below, or may provide a background thereto, for contrast with the image.

In particularly preferred embodiments, the photoluminescent image further comprises a void sub-image in which no visible light emitting photoluminescent quantum dot composition is provided, the void sub-image being defined by and between the at least two different visible light emitting photoluminescent quantum dot compositions. The void sub-image could be formed by the absence of any photoluminescent quantum dot composition, or by the provision of one or more invisible light emitting photoluminescent quantum dot composition(s). That is, the void sub-image contributes to the image by defining regions thereof which require provision of a certain visible colour in just the same way that the photoluminescent sub-images do, but without supplying that visible colour. The void-sub-image can be provided with visible colour by virtue of an illumination process during authentication, as described below, to thereby complete the desired photoluminescent image. This provides an easily testable yet distinctive security effect since only when the correct colour is provided during illumination will the full image appear as intended. For instance, the photoluminescent image may then appear as a full colour image (e.g. an RGB plus white image). If necessary one or more non-luminescent inks may also be applied, e.g. to contribute black to the image, but in other cases any black areas could be formed through the omission of any compositions luminescent in the visible spectrum.

Hence, in especially preferred cases, the at least two visible light emitting different photoluminescent quantum dot compositions include a first photoluminescent quantum dot composition which emits one of red, green or blue light when excited and a second photoluminescent quantum dot composition which emits a different one of red, green or blue light when excited, and the void sub-image corresponds to those parts of the photoluminescent image which require the third one of red, green or blue light, not emitted by either the first or second quantum dot composition. This enables a full colour image to be displayed when the device is illuminated in transmission mode (with a light source of the third, missing, colour). It is particularly advantageous if the first photoluminescent quantum dot composition emits red light when excited, the second photoluminescent quantum dot composition emits green light when excited, and the void sub-image corresponds to parts of the photoluminescent image which require blue light. This is because typical quantum dots have excitation spectra at shorter wavelengths than their emission spectra, and hence blue light can be used to excite quantum dots which emit either red or green light. However, quantum dots with anti-Stokes shifts (i.e. which have excitation spectra at longer wavelengths than their emission spectra) are also available and so other permutations are also feasible.

In another preferred embodiment, the security device further comprises an optical filter which selectively transmits light of a waveband which excites one or more, preferably all, of the at least two visible light emitting photoluminescent quantum dot compositions (and optionally any invisible light emitting QD compositions provided), and wherein the photoluminescent sub-images are arranged such that all of said photoluminescent quantum dot compositions are provided on a first side of the optical filter and at least part, preferably all, of the photoluminescent image overlaps the optical filter. It should be noted that the optical filter could be separate from or integral with the substrate. For instance, the optical filter could take the form of a layer of suitable material printed or otherwise applied to a surface of the substrate, or the substrate material itself could contain the material, e.g. in the form of a dye or pigment. In this way, the security device can be illuminated using a standard white light source through the optical filter to activate the photoluminescent image. The optical filter acts to transmit wavelength(s) required to excite the photoluminescent quantum dot compositions but can be configured to supress some or all other wavelengths such that the luminescent emission is not overwhelmed by the illuminating light can be clearly viewed.

Preferably, the visible colour of the waveband of light selectively transmitted by the optical filter is different from each of the visible colours of the at least two different visible light emitting photoluminescent quantum dot compositions when excited. Thus the light transmitted through the optical filter will contrast with that emitted by the photoluminescent quantum dot compositions and can be used to co-operate with them or to provide a background thereto. Where the security device includes a void sub-image, the colour transmitted by the filter will now define the colour presented by the void sub-image and hence can be used to contribute to the image as explained above. Hence, in a particularly preferred example, the first photoluminescent quantum dot composition emits red light when excited, the second photo luminescent quantum dot composition emits green light when excited, and the visible colour of the wavelength of light selectively transmitted by the optical filter is blue (which will be displayed by the void sub-image).

Any number of visible light emitting photoluminescent quantum dot compositions (and corresponding sub-images) may be provided, preferably with the result that (together with any void sub-image) the photoluminescent image is a full-colour image. Whilst in the preferred cases discussed above, just two compositions are provided to achieve this in combination with a void sub-image, in other cases it may be preferable to provide visible light emitting photoluminescent quantum dot compositions which together provide all of the necessary colour components to achieve a full colour image. Hence in some preferred embodiments, at least three different visible light emitting photoluminescent quantum dot compositions are provided, each arranged according to different respective photoluminescent sub-images, the at least three different visible light emitting photoluminescent quantum dot compositions having different emission spectra from one another, and the same or different excitation spectra, the different emission spectra preferably being predominantly red, green and blue respectively. It is especially preferred if all three sub-images overlap in one or more areas, which will appear white to the viewer due to additive colour mixing. As mentioned above, black areas can be produced by the omission of any visible light emitting luminescent substances in the relevant areas, and/or by the provision of a black non-luminescent ink, e.g. in the form of a further sub-image.

More generally, whatever number of photoluminescent quantum dot compositions are provided, it is preferable if the photoluminescent sub-images are arranged such that the regions of the security device provided with each photoluminescent quantum dot composition are laterally offset from one another, optionally partially overlapping. The areas of partial overlap will display intermediate colours formed by the additive colour mixing of the various emitted colours.

As noted above, the photoluminescent image (and the sub-images which make it up) may be configured so as to be a static image which is exhibited in its desired form when all of the sub-images are activated simultaneously. Hence, the photoluminescent sub-images are configured such that when the photoluminescent sub-images are excited simultaneously the security device exhibits the multi-coloured photoluminescent image.

In other cases, the image can be configured for viewing in stages—that is, only part of it at a time. In this case, the photoluminescent sub-images are preferably arranged such that they define at least two laterally offset regions having different excitation spectra, optionally partially overlapping. In particularly preferred embodiments, the photoluminescent sub-images have different excitation spectra and are each configured to define a different one of a set of image frames which, when excited sequentially, exhibit the multi-coloured photoluminescent image, which is animated. For instance, the animated photoluminescent image may exhibit one or more of the following effects: movement, morphing; switching; zooming; expansion; and contraction. An animated photoluminescent image such as this provides a particularly distinctive security effect, and exemplary methods for authenticating such devices will be discussed below.

As mentioned at the outset, one particular benefit of quantum dots is that many can be excited by wavelengths which are closer to their emission colour than can conventional luminescent materials. Hence, it is strongly preferred that at least one of said photoluminescent compositions, preferably each, can be excited by light in the visible spectrum, for example wavelengths in the range 380 to 780 nm. It will be appreciated that each composition will not typically be responsive to all visible wavelengths, but rather by one or a sub-set thereof.

Advantageously, at least one of said photoluminescent compositions, preferably each, is a printed layer, preferably applied by one of: a digital printing method such as inkjet printing, dye sublimation or laser printing; lithographic printing, flexographic printing, intaglio printing, gravure printing, screen printing, letterpress printing or vapour deposition. Digital printing methods offer particular advantages over conventional security print techniques since they do not require the production of a “master” printing plate or cylinder, but rather can be controlled “on the fly” by a computer or other suitably programmed controller. This means that they can be used to print personalised or unique information, which differs from one instance of the device to the next. Quantum dot compositions are particularly well suited to such digital printing methods, especially inkjet printing, because unlike most conventional luminescent substances, the individual particles are very small (e.g. 100 nm or less in diameter) and hence do not block the nozzles of an inkjet print head.

The quantum dots can be carried in a suitable binder such as an ink and thus preferably at least one of said photoluminescent quantum dot compositions comprises quantum dots in an at least semi-transparent medium. The medium may contain other substances such as conventional colour pigments or dyes, although preferably the composition appears white, off-white or colourless when the quantum dots therein are not excited. The concentration of the quantum dots in the composition may be selected (and/or balanced with other substance within the composition) such that any light they emit under standard ambient lighting conditions is substantially quenched or disguised. In preferred embodiments, at least two of the photoluminescent quantum dot compositions, preferably all, have substantially the same visible colour as one another when their quantum dots are not excited. This same visible colour may be white, off-white or colourless, but could also be some other colour such as red, blue, grey, black etc. In this way, the presence of a multi-coloured photoluminescent image is better concealed when the quantum dots are not activated.

Advantageously, the photo-luminescent image comprises a human-intelligible item of information (as opposed to a code which is only machine-readable), preferably any of at least one: letter; number; alphanumerical text; portrait; symbol; logo; pattern; image; photograph; or graphic. For example, the image could be a passport photo. It is particularly advantageous to use the security device to form personalisation information such as this, since as discussed above, it has previously been difficult or impossible to provide such information with photo-luminescent characteristics. Alternatively or in addition, the image can provide machine-readable information such as a 1-D or 2-D barcode.

As mentioned above, the sub-images each correspond to the areas of the image which require contribution from the colour emitted by the respective quantum dot image, and so these will each tend to extend over macro-scale areas of the device. Preferably, however, within each photoluminescent sub-image, the respective photoluminescent quantum dot composition is laid down in accordance with a pixel array or screened grid of elements, preferably a halftone screen. Hence each composition may be discontinuous within each sub-image on a microscopic scale. This corresponds to conventional techniques for printing multi-coloured images via multiple workings. It will be appreciated that the various sub-images are preferably applied in register to one another.

The whole substrate could be at least semi-transparent, as indicated previously. However, in more preferred cases, the at least semi-transparent region is a window adjacent a relatively visually opaque region of the substrate. For instance, the window may be a half-window or (more preferably) a full-window and may be partially or wholly surrounded by less transparent region(s) of the substrate. In one example, the substrate may be that of a polymer security document such as a banknote and the at least semi-transparent region may be a window defined by the omission of opacifying material applied to the substrate elsewhere. Alternatively, the substrate could be a transparent thread, foil or stripe which is applied to or incorporated into a document formed of paper or another opacifying material which defines the window with an aperture therethrough (full or partial thickness).

Thus, the first aspect of the invention further provides a security article comprising a security device as described above, wherein preferably the security article is a thread, stripe, patch, foil, transfer foil or insert. Also provided is a security document comprising a security device or a security article, each as described above, wherein preferably the security document is a banknote, identity document, passport, cheque, visa, license, certificate or stamp.

The invention also provides a method of authenticating a security device according to the first aspect, wherein the at least two visible light emitting photoluminescent quantum dot compositions include:

a first photoluminescent quantum dot composition having a first excitation spectra and a first emission spectra; and

a second photoluminescent quantum dot composition having a second excitation spectra and a second emission spectra;

the method comprising:

illuminating the photoluminescent image with light of the first excitation spectra and of the second excitation spectra such that the security device exhibits the photoluminescent sub-images of the first and second photoluminescent quantum dot compositions simultaneously.

As already explained, in this first aspect of the invention the at least two visible light emitting photoluminescent quantum dot compositions have different emission spectra and the same or different excitation spectra, so here the first and second emission spectra are different from one another, whereas the first and second excitation spectra could be the same or different from one another. In this method, the first and second compositions are activated simultaneously, preferably through the at least semi-transparent portion of the substrate as mentioned previously, such that both visible emitted colours (and/or any mixed colours formed by overlap) are exhibited alongside one another to thereby form the desired image. It should be noted that the light used to illuminate the photoluminescent image need not include the whole of either excitation spectra, but will need to include at least one wavelength from each excitation spectra (which may be a single wavelength if they overlap). It should also be noted that the wavelength (or waveband) of light emitted by the light source(s) used for the illumination may not be the same as that which reaches and thereby illuminates the photoluminescent image, e.g. if an optical filter is provided as mentioned above. However, the light emitted by the light source(s) should include the necessary wavelengths.

As explained above it is preferable to use the at least semi-transparent region to view the image in a transmissive illumination mode, and hence preferably illuminating the photoluminescent image comprises:

positioning the security device between a viewer and a light source (which term includes multiple light sources) emitting light of the first excitation spectra and of the second excitation spectra, such that the portion of the photoluminescent image which overlaps the at least semi-transparent region of the security device is either: illuminated through the at least semi-transparent region; or is visible to the viewer through the at semi-transparent region.

In some preferred cases, the first excitation spectra and the second excitation spectra are the same or overlap and illuminating the photoluminescent image may comprise illuminating the photoluminescent image with light having a wavelength within the first and second excitation spectra. The first excitation spectra and the second excitation spectra are different (and need not overlap) and illuminating the photoluminescent image may comprise illuminating the photoluminescent image with light having a waveband which includes a wavelength within the first excitation spectra and a wavelength within the second excitation spectra.

Typically, the emission spectra of each photoluminescent quantum dot composition will be different from its respective excitation spectra although there may be some overlap.

In preferred embodiments, as described above, the photoluminescent image further comprises a void sub-image in which no visible light emitting photoluminescent quantum dot composition is provided, the void sub-image being defined by and between the at least two different visible light emitting photoluminescent quantum dot compositions. As before the void sub-image could correspond to an absence of any QD composition, or could comprise only invisible light emitting QDs. Now, when the photoluminescent image is illuminated with light, the void sub-image reflects and/or transmits (depending on how the illumination is arranged) at least one or more wavelengths of the illuminating light. Thus, the colour of the illuminating light can be selected or controlled to provide the void sub-image with a desired colour in order to complete or modify the appearance of the photoluminescent image. For example, in advantageous implementations, the visible colours emitted by the visible light emitting photoluminescent quantum dot compositions and that of the at least one or more wavelengths of the illuminating light reflected or transmitted by the void sub-image may be selected such that, when illuminated, the photoluminescent image exhibited by the security device is a full colour image (e.g. a RBG+white image) formed by the photoluminescent sub-images and the void sub-image. As mentioned previously, black parts of the image may be formed by the omission of any luminescing composition and/or by the provision of a black non-luminescent ink sub-image.

Depending on the construction of the device, the void sub-image may transmit or reflect the whole waveband of the illuminating light from the light source (e.g. if the construction is colourless), in which case the void sub-image will appear in the same colour as the illuminating light, or only some of that waveband (e.g. where the device comprises an optical filter), in which case the void sub-image will appear in a different colour. In the case where the void sub-image reflects and/or transmits all visible wavelengths of the illuminating light, it is preferable that the first photoluminescent quantum dot composition emits one of red, green or blue light when excited and the second photoluminescent quantum dot composition emits a different one of red, green or blue light when excited, and the void sub-image corresponds to those parts of the photoluminescent image which require the third one of red, green or blue light, not emitted by either the first or second quantum dot composition, and wherein the illuminating light is the third one of red, green or blue light, not emitted by either the first or second quantum dot composition. In this way, a full colour RGB image can be formed by the first and second photoluminescent quantum dot compositions and the illuminating light in combination. In particular preferred embodiments, the first photoluminescent quantum dot composition emits red light when excited, the second photo luminescent quantum dot composition emits green light when excited, and the void sub-image corresponds to parts of the photoluminescent image which require blue light, and wherein the illuminating light is blue. As mentioned above, typical quantum dots will emit at a longer wavelength than that which excites them and hence blue light can be used to activate red and green emitting quantum dot compositions.

In other preferred embodiments, the security device further comprises an optical filter which selectively transmits light of a waveband which excites one or more, preferably all, of the at least two photoluminescent quantum dot compositions, the photoluminescent sub-images being arranged such that all of said photoluminescent quantum dot compositions are provided on a first side of the optical filter and at least part, preferably all, of the photoluminescent image overlaps the optical filter, and wherein illuminating the security device comprises positioning the security device between the viewer and a light source such that the optical filter is between the photoluminescent quantum dot compositions and the light source, the light source preferably being a white light source. This enables the apparent colour of the void sub-image to be controlled through selection of the optical filter rather than the light source.

Hence where the at least one wavelength of the illuminating light transmitted by the void sub-image corresponds to the waveband transmitted by the optical filter, the first photoluminescent quantum dot composition preferably emits one of red, green or blue light when excited and the second photoluminescent quantum dot composition emits a different one of red, green or blue light when excited, and the void sub-image corresponds to those parts of the photoluminescent image which require the third one of red, green or blue light, not emitted by either the first or second quantum dot composition, and wherein the visible colour of the waveband transmitted by the optical filter is the third one of red, green or blue light, not emitted by either the first or second quantum dot composition. This enables a full colour RGB image to be formed as before. Again, it is preferred that the first photoluminescent quantum dot composition emits red light when excited, the second photo luminescent quantum dot composition emits green light when excited, and the void sub-image corresponds to parts of the photoluminescent image which require blue light, and wherein the visible colour of the waveband transmitted by the optical filter is blue.

Any form of light source could be used to perform the illumination, such as a torch, lamp or light bulb. However, in an especially preferred implementation, the light source comprises a display screen configured to emit light of the first excitation spectra and of the second excitation spectra across an area corresponding to all or part of the photoluminescent image, the security device preferably being placed against the display screen. For instance, the display screen may preferably be the display of a mobile electronic device, more preferably the display of a mobile telephone or tablet computer, although less portable display screens such as those of televisions or desktop computer monitors could alternatively be used. Such display devices are readily available to both professionals (such as bank tellers) and the man in the street, making it possible for a wide range of users to perform the authentication to the same standard. The security device can be placed against the display screen and viewed thereon to visualise the activated photoluminescent image. The display screen can be controlled to emit light of an appropriate wavelength or waveband (e.g. white light, or blue light) across all or a part of its area which preferably is at least as big as the area of the photoluminescent image. Any necessary control of the display screen can be achieved manually by a user and/or by an appropriately configured computer program, such as an “app” on a mobile telephone or tablet computer. If desired, the program could be further configured to additionally display an image of how the activated photoluminescent image should appear, so that the user can compare the two directly.

In accordance with a second aspect of the invention, a security device is provided, comprising:

a substrate; and

a photoluminescent image disposed on or in the substrate, the photoluminescent image comprising at least two different visible light emitting photoluminescent quantum dot compositions, each arranged according to different respective photoluminescent sub-images, the at least two different visible light emitting photoluminescent quantum dot compositions having different excitation spectra from one another, and the same or different emission spectra;

wherein the respective photoluminescent sub-images are each configured to define a different one of a set of image frames which, when excited sequentially, exhibit the photoluminescent image, which is animated.

By arranging the photo-luminescent sub-images to combinedly form an animated photoluminescent image, a strong and distinctive new security effect is achieved as referred to in passing above. In this case, the appearance of the device when more than one of the sub-images is activated may or may not be an intelligible image. In addition, whilst the at least two visible light emitting photoluminescent quantum dot compositions will be excited by different wavelengths, they may optionally emit light at or near the same wavelength as each other, in which case the animated device may be of a single colour.

Unlike the security device according to the first aspect of the invention, it is not essential that the security device of the second aspect has an at least semi-transparent region of the substrate. The entire substrate could be opaque and the photoluminescent image configured for viewing under reflected light only (in which case all of the sub-images would need to be arranged on the same surface of the substrate). However, the provision of an at least semi-transparent region of the substrate and the arrangement of all or part of the image to overlap it is still preferred for all the same reasons as previously mentioned.

The sub-images could be configured to generate any animated effect upon sequential activation. For instance, preferably, the animated photoluminescent image exhibits one or more of the following effects: movement, morphing; switching; zooming; expansion; and contraction. Preferred techniques for activating the sub-images in a particular order so as to visualise the intended animation effect will be described below.

Whilst the animated image could appear in a single colour, as mentioned above, it is preferable that the at least two different visible light emitting photoluminescent quantum dot compositions have different emission spectra from one another, the at least two different visible light emitting photoluminescent quantum dot compositions thereby emitting different respective visible colours from one another when excited, whereby the animated photoluminescent image is multi-coloured. This further increases the visual impact and hence the security level.

Any of the preferred features of the security device according to the first aspect of the invention could equally be applied to the security device according to the second aspect, including for example a void sub-image and/or an optical filter.

One or more invisible light emitting photoluminescent QD compositions could also be provided.

The second aspect of the invention further provides a security article comprising a security device as described above, wherein preferably the security article is a thread, stripe, patch, foil, transfer foil or insert. Also provided is a security document comprising a security device or a security article, each as described above, wherein preferably the security document is a banknote, identity document, passport, cheque, visa, license, certificate or stamp.

The second aspect of the invention further provides a method of authenticating a security device, the security device comprising:

a substrate; and

a photoluminescent image disposed on or in the substrate, the photoluminescent image comprising at least two different visible light emitting photoluminescent quantum dot compositions, each arranged according to different respective photoluminescent sub-images, the at least two different visible light emitting photoluminescent quantum dot compositions having the same or different emission spectra from one another, and different excitation spectra;

the method comprising the steps of:

sequentially illuminating the photoluminescent image with light of different wavelengths, such that the at least two different visible light emitting photoluminescent quantum dot compositions are excited sequentially and the security device exhibits the photoluminescent sub-images sequentially.

The security device used in this method could (for example) be a security device in accordance with the first aspect of the invention or a security device in accordance with the second aspect of the invention. By sequentially activating the sub-images in the manner described, it can be determined that each has different excitation spectra (because the image will appear different when illuminated with appropriate different wavelengths) and hence the device can be distinguished from counterfeit versions made using one type of quantum dots combined with different ink colours, for example.

In preferred implementations, sequentially illuminating the photoluminescent image comprises:

illuminating the photoluminescent image with light at a first wavelength, wherein the first wavelength is within the excitation spectra of a first photoluminescent quantum dot composition of the at least two visible light emitting photoluminescent quantum dot compositions but not within the excitation spectra of a second photoluminescent quantum dot composition of the at least two visible light emitting photoluminescent quantum dot compositions, such that the security device exhibits a first photoluminescent sub-image; and then

illuminating the photoluminescent image with light at a second wavelength, wherein the second wavelength is within the excitation spectra of the second photoluminescent quantum dot composition but not within the excitation spectra of the first photoluminescent quantum dot composition, such that the security device exhibits a second photoluminescent sub-image.

The steps of illuminating the photoluminescent image with light at the first wavelength and illuminating the photoluminescent image with light at the second wavelength may preferably be performed alternately or periodically. If the security device comprises more than two visible light emitting photoluminescent quantum dot compositions, for example, there may be a corresponding number of illumination steps each with a different wavelength for activating each sub-image respectively. The various wavelengths can be used in sequence to activate the different sub-images in any desired order or pattern, which may be cyclical such that each wavelength is used in a periodic manner. Alternatively the sequence may be random or pseudo-random.

Optionally, sequentially illuminating the photoluminescent image may further comprises a step of either:
illuminating the photoluminescent image with light at a third wavelength, wherein the third wavelength is within the excitation spectra of the first and second photoluminescent quantum dot compositions; or
illuminating the photoluminescent image with light at the first wavelength and second wavelength simultaneously;

such that the security device exhibits the first and second photoluminescent sub-images simultaneously.

In this way, both sub-images will be activated simultaneously for the duration of this step. If there are more than two visible light emitting photoluminescent quantum dot compositions and corresponding sub-images this step may involve activating all of them or only some of them. A step of this sort may be inserted between steps of illuminating the image only with light of the first wavelength and only with light of the second wavelength such that the image appears to more smoothly transition between the first and second sub-images.

It is not essential that the security device being authenticated be specially designed for viewing in this manner—for instance, the image could be a static image which is configured to appear as desired when all of the sub-images are activated. However, in more preferred embodiments, the photoluminescent sub-images define are each configured to define a different one of a set of image frames which, when excited sequentially, exhibit the photoluminescent image, which is animated. The animation effect may preferably include at least one of: movement, morphing; switching; zooming; expansion and contraction for example. This results in a particularly distinctive visual effect and hence a higher security level.

Most preferably, at least a portion of the photoluminescent image overlaps an at least semi-transparent region of the substrate. As discussed in relation to the first aspect of the invention this has the significant benefit that the device can be viewed in a trans-illumination mode and hence the distance between the image and light source can be reduced without obscuring the user's view.

Thus, preferably, sequentially illuminating the photoluminescent image comprises positioning the security device between a viewer and one or more light sources, such that the portion of the photoluminescent image which overlaps the at least semi-transparent region of the security device is either: illuminated by the light source(s) through the at least semi-transparent region; or is visible to the viewer through the at semi-transparent region. Any suitable light source can be used but again it is particular advantageous if the photoluminescent image is illuminated using a display screen configured to display light of different wavelengths sequentially, preferably by placing the security device against the display screen. Any available display screen could be used, such as that of a television, desktop computer or laptop computer, but most preferably the display screen is the display of a mobile electronic device, more preferably the display of a mobile telephone or tablet computer.

As described in relation to preferred implementations of the method according to the first aspect of the invention, the display screen can be controlled to emit the required wavelengths of light to achieve the desired illumination of the security device, for instance though the execution of an appropriate program or app. The program can control the display screen to emit light of the first wavelength and then to switch to emit light of the second wavelength, such that if the security device is viewed against the screen, the first sub-image will be seen, followed by the second. Any number of different wavelengths may be emitted by the display screen, under the control of the program or app, so as to activate corresponding sub-images of the security device and hence cause an animated effect to appear, if the security device is configured as such. The order in which the different wavelengths are emitted may be chosen so that the respective corresponding sub-images are activated in a particular order, which may be necessary to create the desired animation. The duration of each illumination step may be sufficiently long for the activated sub-image to be distinguishable from the preceding and subsequently activated sub-images, or it may be shorter in order to create a smooth animation effect without the individual frames being distinguishable. As before, the display screen need not emit the required wavelengths over its whole area, but only a part thereof large enough to place the photoluminescent image over. Another part of the display screen could be used to display an image of how the security device should appear, alongside the location at which the security device itself will be placed, so that the two can be easily compared.

As already discussed in relation to the first aspect of the invention, in preferred embodiments, the security device further comprises an optical filter which selectively transmits light of a waveband which excites one or more of the photoluminescent quantum dot compositions, preferably all, and wherein the photoluminescent sub-images are arranged such that all of said photoluminescent quantum dot compositions are provided on a first side of the optical filter and part of the photoluminescent image, preferably all, overlays the optical filter. In this case, it is preferred that the step of sequentially illuminating the photoluminescent image comprises illuminating the photoluminescent image through the optical filter.

It is also preferable that the photoluminescent image further comprises a void sub-image in which no visible light emitting photoluminescent quantum dot composition is provided, the void sub-image being defined by and between the at least two different photoluminescent quantum dot compositions. As in the first aspect of the invention this can be used to complete the desired appearance of the photoluminescent image by imparting a particular colour to the void sub-region through controlled illumination thereof or otherwise. Again, the void sub-image could be defined by the absence of any QD composition or by the presence of only invisible light emitting QD compositions.

In this second aspect of the invention, the various visible light emitting photoluminescent quantum dot compositions could emit at or near the same wavelength as one another since the sub-images will be activated by different wavelengths to achieve a secure effect. However, still it is preferable if the at least two different visible light emitting photoluminescent quantum dot compositions have different emission spectra from one another, the at least two different photoluminescent quantum dot compositions thereby emitting different respective visible colours from one another when excited, whereby the photoluminescent image is multi-coloured. This further enhances the appearance of the device and hence elevates the security level.

In particularly preferred embodiments, the at least two different photoluminescent quantum dot compositions include a first photoluminescent quantum dot composition which emits one of red, green or blue light when excited and a second photoluminescent quantum dot composition which emits a different one of red, green or blue light when excited, and the void sub-image corresponds to those parts of the photoluminescent image which require the third one of red, green or blue light, not emitted by either the first or second quantum dot composition. In this way, a full colour RGB image can be formed. It should also be noted that multiple different quantum dot compositions could be provided which emit the same colour (e.g. red) but at different excitation wavelengths. Thus, the same set of colours (e.g. RGB) could be displayed in each illumination step but with different lateral extents corresponding to the different sub-images, so as to give rise to a full colour animation effect. In another example, the first photoluminescent quantum dot composition may emit red light when excited, the second photo luminescent quantum dot composition emits green light when excited, and the void sub-image corresponds to parts of the photoluminescent image which require blue light.

As in the first aspect of the invention, it is advantageous if at least two of the photoluminescent quantum dot compositions, preferably all, have substantially the same visible colour as one another when their quantum dots are not excited. This helps to conceal the presence of the security device under standard illumination conditions.

Again, the quantum dot compositions lend themselves to being laid down by digital printing techniques such as inkjet printing and as such in preferred embodiments, the photoluminescent image may comprise personalisation information or a unique identifier which is specific to the individual security device in question. More generally, it is advantageous if the photo-luminescent image comprises a human-intelligible item of information, preferably any of at least one: letter; number; alphanumerical text; portrait; symbol; logo; pattern; image; photograph; or graphic. For instance, the image could comprise a passport photo, which may be animated (e.g. showing the person turning their head from side to side) or might be exhibited in only one (or a subset of) the illumination steps, with other indicia exhibited in other steps.

As in the first aspect of the invention, each sub-image defines areas requiring a contribution from the colour emitted by the respective quantum dot composition. Within each photoluminescent sub-image, the respective photoluminescent quantum dot composition is advantageously laid down in accordance with a pixel array or screened grid of elements, preferably a halftone screen.

Examples of security devices, security articles, security documents and methods for authentication thereof in accordance with the present invention will now be described with reference to the accompanying drawings, in which:

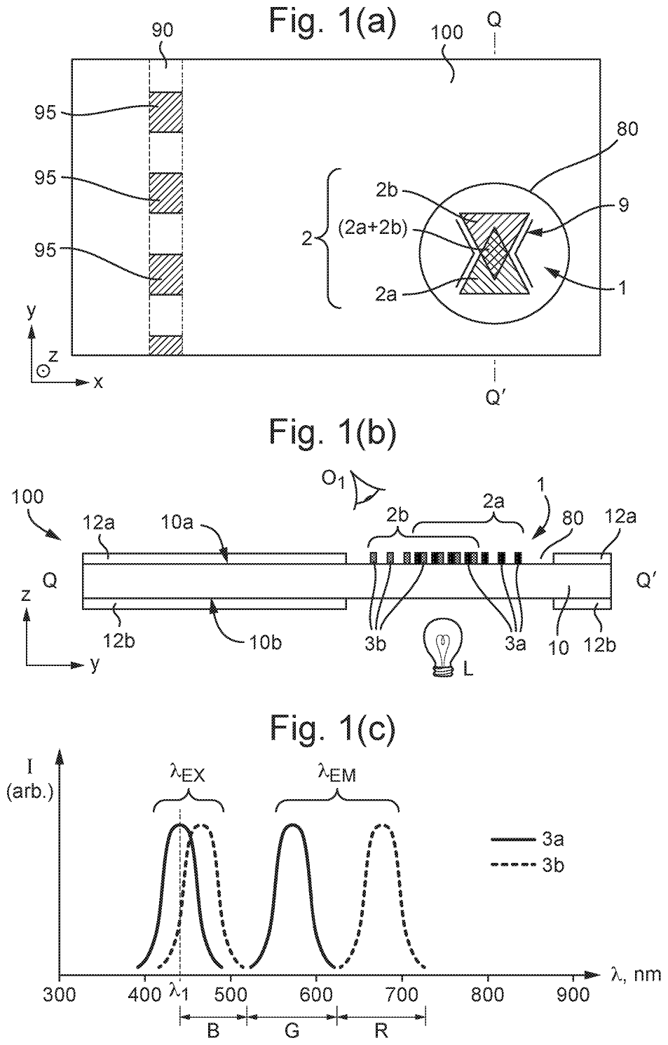

FIG. 1 depicts a security document according to a first embodiment of the invention, (a) in plan view and (b) in cross-section along the line Q-Q′ shown in FIG. 1(a), and FIG. 1(c) shows exemplary excitation and emission spectra of the QD compositions used;

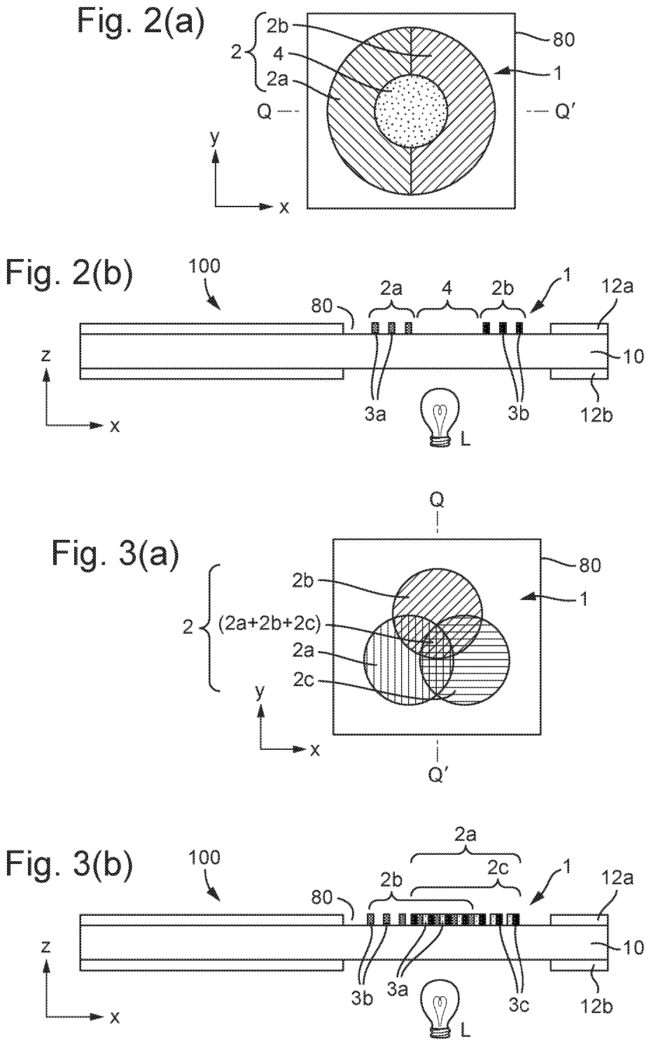

FIG. 2 illustrates a security device according to a second embodiment of the invention, (a) in plan view and (b) in cross-section along the line Q-Q′ shown in FIG. 2(a);

FIG. 3 shows a security device in accordance with a third embodiment of the present invention, (a) in plan view and (b) in cross-section along the line Q-Q′ shown in FIG. 3(a);

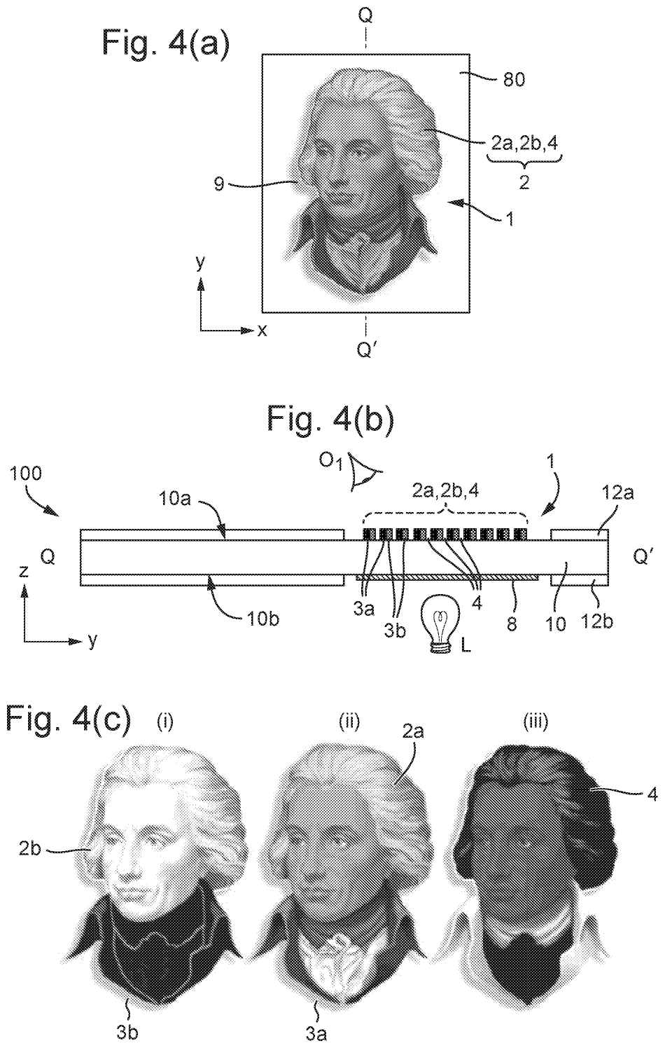

FIG. 4 illustrates a security device in accordance with a fourth embodiment of the present invention, (a) in plan view, (b) in cross-section shown along the line Q-Q′ shown in FIG. 4(a), and FIGS. 4(c)(i), (ii) and (iii) depict three respective sub-images making up the security device shown in FIG. 4(a);

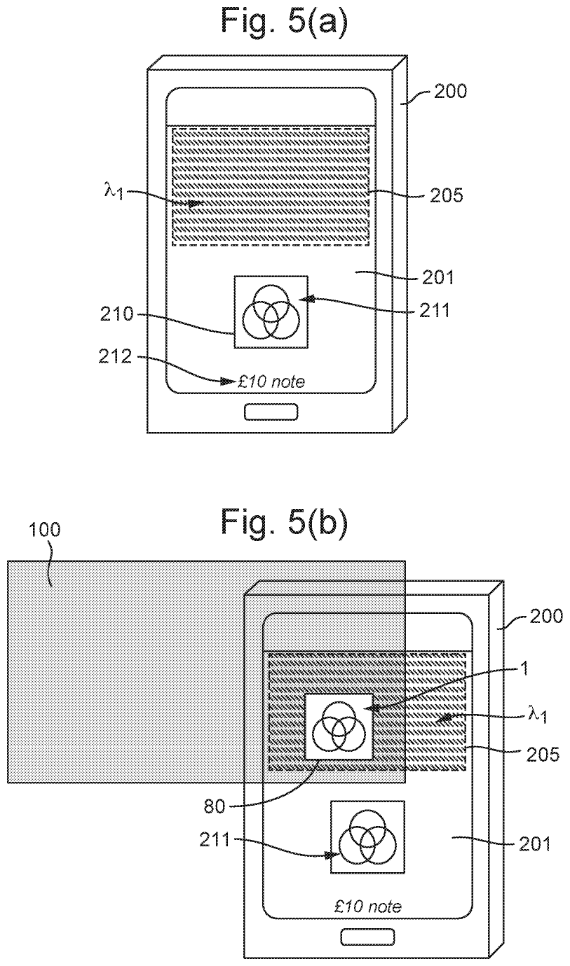

FIG. 5(a) schematically depicts an example of apparatus suitable for use in a first embodiment of a method for authenticating a security device, and FIG. 5(b) shows the apparatus of FIG. 5(a) in use with an exemplary security document;

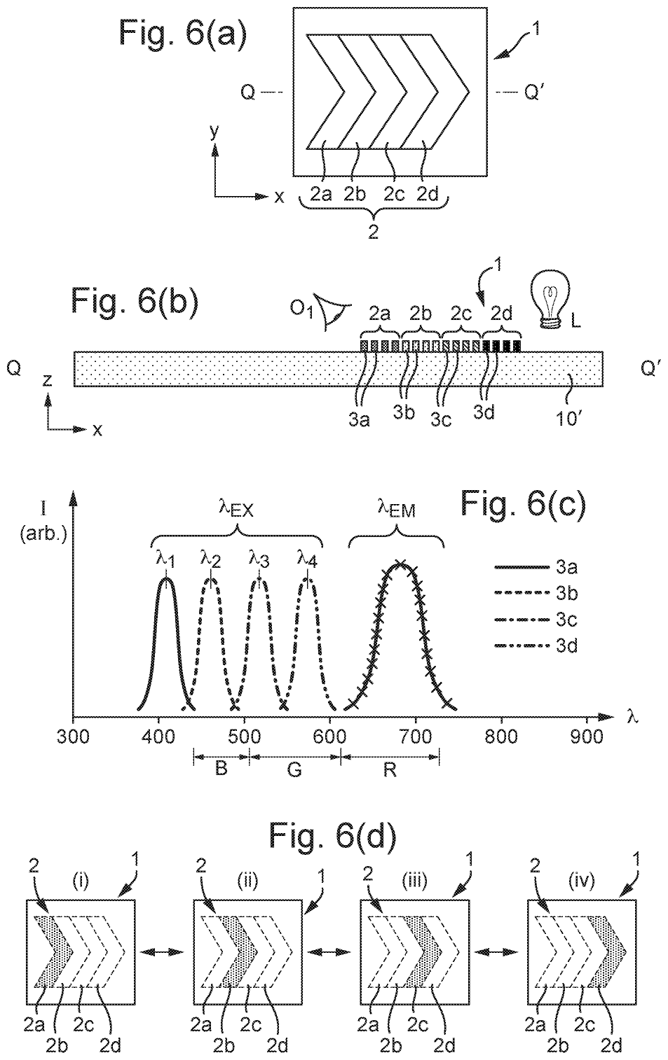

FIG. 6 depicts a security device in accordance with a fifth embodiment of the invention, (a) in plan view, (b) in cross-section along the line Q-Q′, FIG. 6(c) depicting exemplary excitation and emission spectra of the QD compositions used, and FIGS. 6(d)(i), (ii), (iii) and (iv) showing the appearance of the security device in different respective illumination steps;

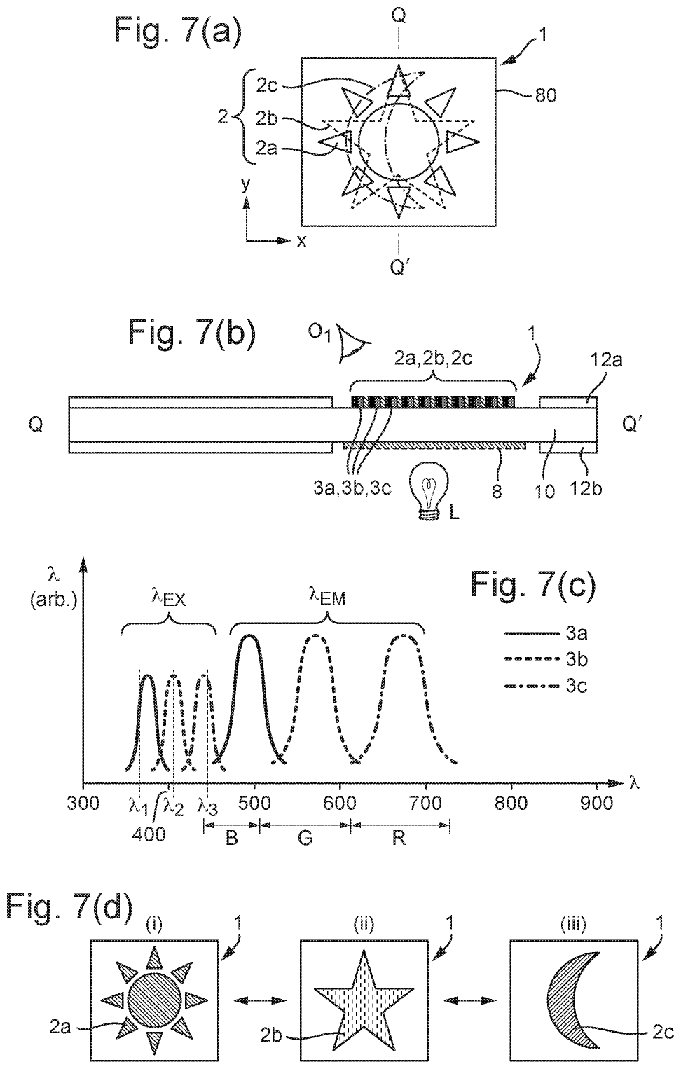

FIG. 7 depicts a security device in accordance with a sixth embodiment of the invention, (a) in plan view and (b) in cross-section along the line Q-Q′ shown in FIG. 7(a), FIG. 7(c) depicting exemplary excitation and emission spectra suitable for the QD compositions used, and FIGS. 7(d)(i), (ii) and (iii) show the appearance of the security device in three different illumination steps;

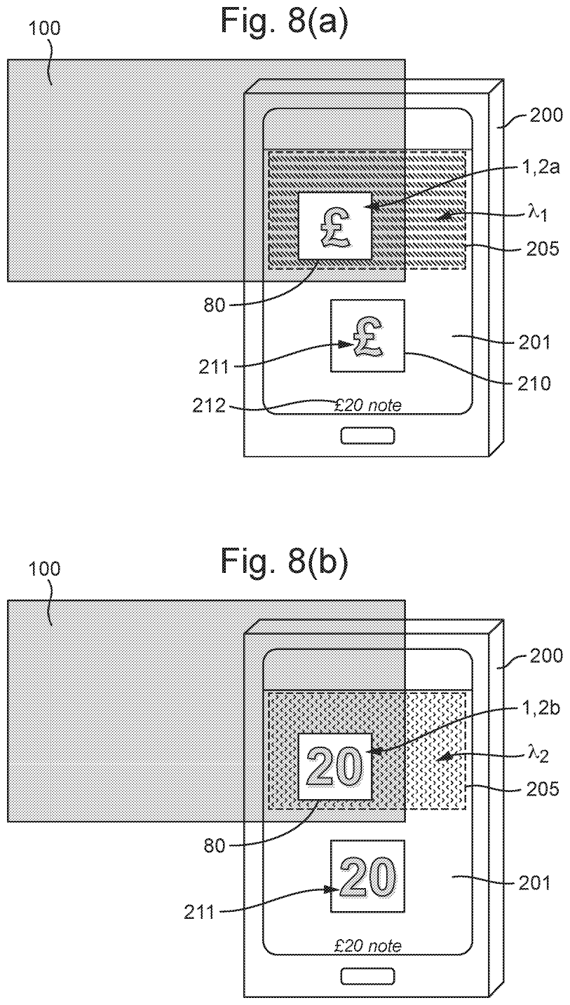

FIGS. 8(a) and (b) illustrate the exemplary authentication apparatus of FIG. 5(a) used in a second embodiment of a method of authenticating a security device, in two different illumination steps;

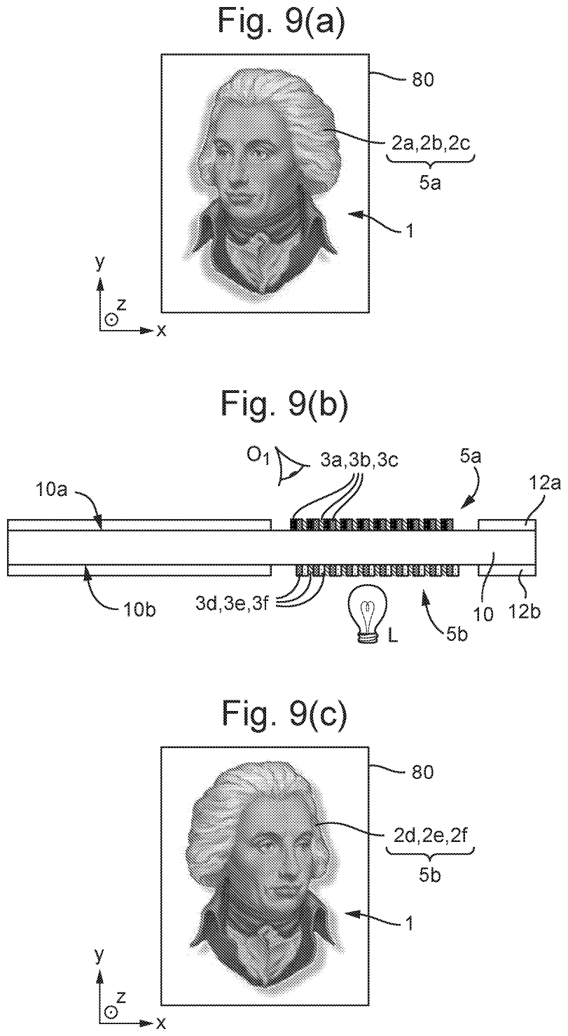

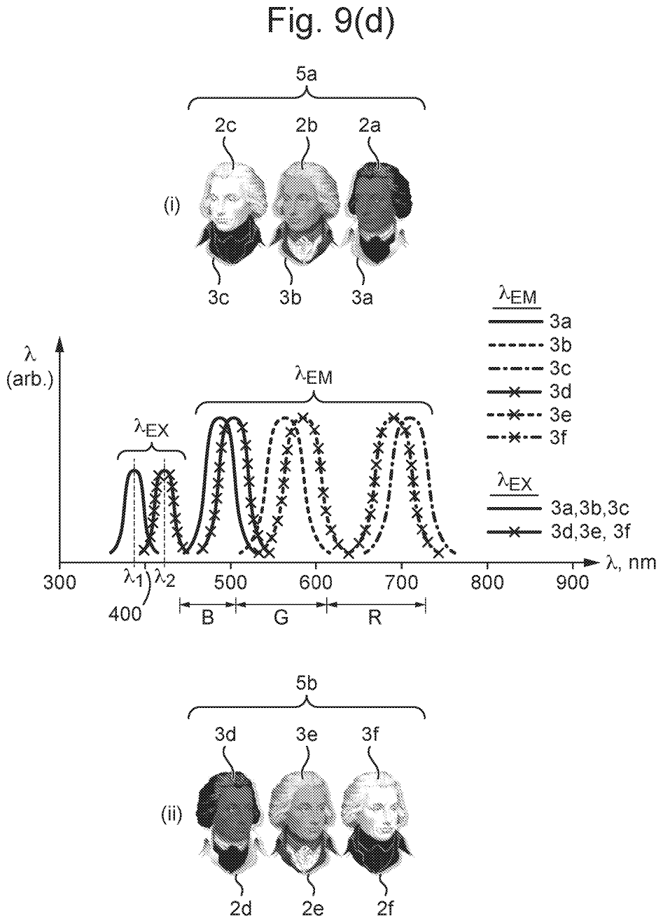

FIG. 9 depicts a seventh embodiment of a security device in accordance with the present invention, (a) in plan view in a first illumination step, (b) in cross-section, (c) in plan view in a second illumination step, FIG. 9(d) illustrating exemplary excitation and emission spectra for the QD compositions used and, in (i) and (ii), six sub-images from which the security device is formed;

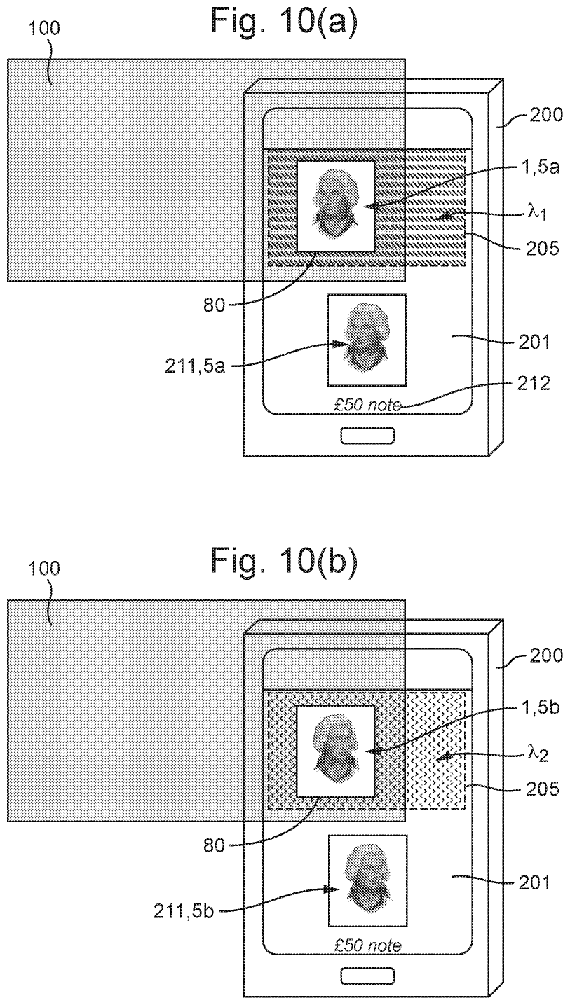

FIGS. 10(a) and (b) illustrate the exemplary authentication apparatus of FIG. 5(a) used to authenticate an exemplary security document carrying the security device of FIG. 9, in two different illumination modes.

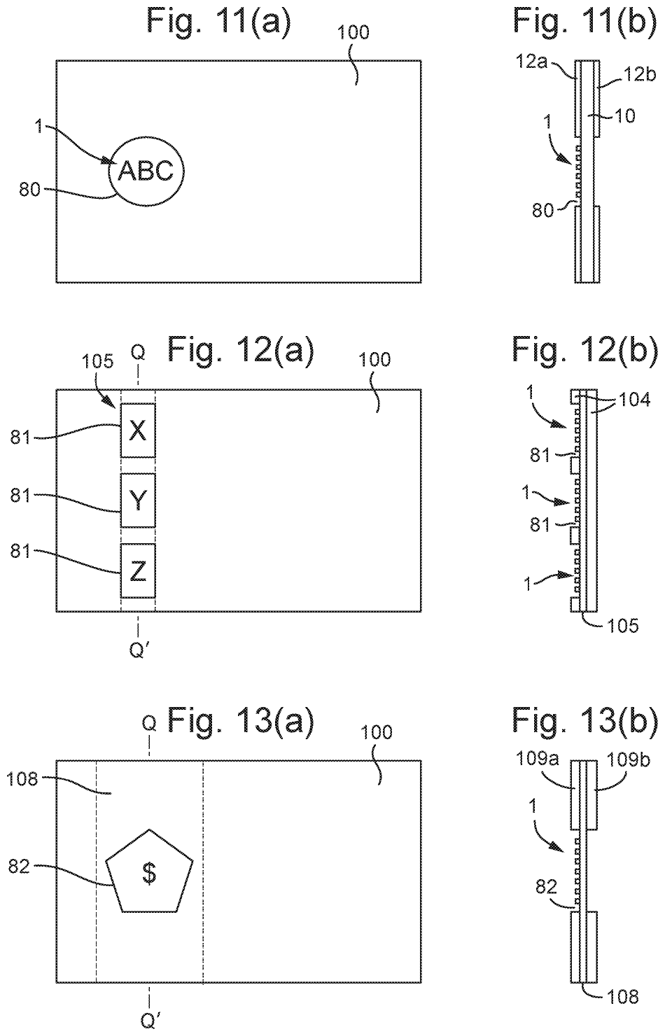

FIGS. 11, 12 and 13 show three exemplary articles carrying optical devices in accordance with embodiments of the present invention (a) in plan view, and (b) in cross-section; and

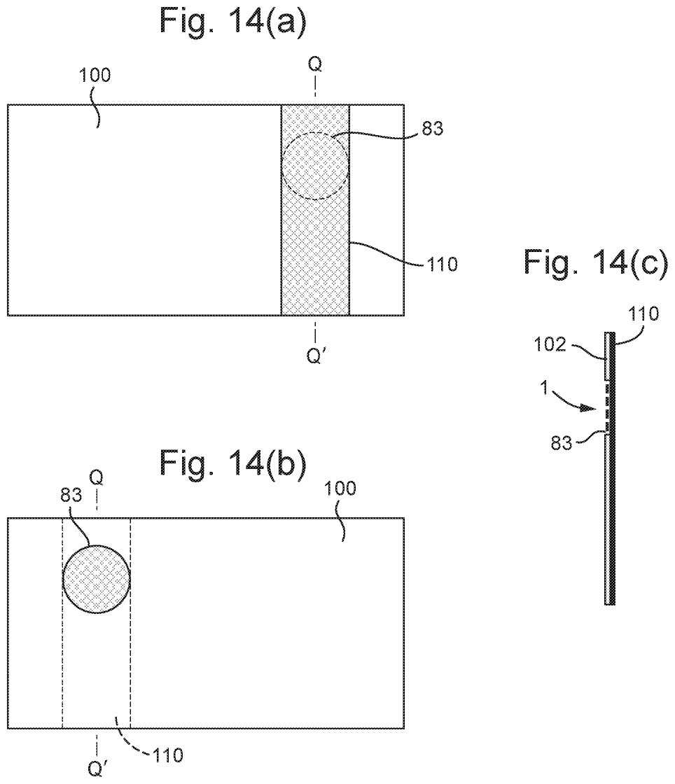

FIG. 14 illustrates a further embodiment of an article carrying an optical device in accordance with the present invention, (a) in front view, (b) in back view and (c) in cross-section.

Throughout the description below, frequent reference will be made to photoluminescent quantum dot compositions or “QD compositions” for short. Quantum dots (“QDs”) are small particles of various semiconductor materials, typically of the order of nanometres in diameter, which emit specific frequencies of light when excited by an incident wavelength to which the particular QD is responsive. The wavelength(s) over which a particular quantum dot will emit (and hence its emitted colour) are defined by its emission spectrum, and the wavelength(s) which will excite it to emit that colour are defined by its excitation spectrum. Both of these spectra can be precisely tuned by changing the size of the quantum dots, their shape and/or their material. Typically, smaller quantum dots (having a diameter between 2 and 3 nanometres, for example) emit colours at the short wavelength end of the visible spectrum (e.g. blue or green) whilst larger quantum dots (having a diameter of between 5 and 6 nanometres, for example) emit longer wavelength colours such as orange or red. Examples of quantum dots suitable for use in embodiments of the present invention are disclosed in US-A-2004/0233465 as well as in EP-A-2025525. For each embodiment described below, quantum dot compositions can be selected from the various types disclosed therein in accordance with the general requirements placed on their emission and/or excitation spectra by each embodiment as explained below.

All embodiments require the use of at least two different visible light emitting QD compositions, which will emit visible light when excited. Such compositions may or may not also emit light outside the visible spectrum when excited. Throughout the description below, the QD compositions mentioned are of this sort unless explicitly indicated otherwise.

In all embodiments, it is preferred to select quantum dot compositions with much smaller Stokes shifts than those of conventional fluorescent materials, for example of the order of 50 nanometres rather than around 100 nanometres as is more conventional. This enables the quantum dots to be activated either by visible light or light at the edge of the visible spectrum. This greatly increases the variety of light sources which can be used to activate the quantum dots and for example, a directional torch such as those commonly found on cameras or smartphones could potentially be used as the illuminator. Whilst it is more usual for QDs to have emission spectra at longer wavelengths than their excitation spectra, QDs with “anti-Stokes” shifts are also available, which are excited by wavelengths longer than those they emit.

The quantum dots are typically contained in an otherwise conventional ink binder composition or similar, which may or may not contain additional substances such as pigments which are visibly coloured under normal ambient lighting conditions. For example, such pigments may be utilised to help conceal the presence of the quantum dots under standard diffuse lighting (e.g. daylight), for example by giving the composition a white or off-white light base colour. In other cases, the compositions may be transparent and preferably colourless under ambient illumination, such that they can be seen through.

In all embodiments, the various QD compositions can be applied using any convenient technique, such as printing. Conventional security print techniques such as intaglio printing, flexographic printing, lithographic printing and the like can be used, which is particularly desirable where high resolution is the overriding factor. However, due to their small size, quantum dots also lend themselves well to digital printing techniques which do not require the formation of a “master”, such as inkjet printing, diffusion printing and laser printing. Such digital printing techniques are particularly preferred manufacturing techniques for the present invention since this enables the formation of unique and/or personalised security devices, which differ from one instance of the security device to the next, such as passport photos or bibliographic data relating to the holder of the document. Examples will be given below. The various QD compositions forming each security device are preferably applied in sufficiently accurate register with one another such that the different sub-images appear registered to the naked human eye. For instance a registration tolerance of around 100 microns may be acceptable. Techniques for achieving this are well known and available from conventional multi-colour printing techniques.

FIG. 1 schematically shows a security document 100 having a security device 1 thereon, in accordance with a first embodiment of the invention. The security document 100 is shown in plan view in FIG. 1(a) and in cross-section in FIG. 1(b), taken along the line Q-Q′ depicted in FIG. 1(a). In this example, the security document 100 is a banknote but could be any other document of value such as a passport, identification document, identification card, visa, certificate or the like. The security document may also be provided with additional security features such as security article 90 illustrated, which in this example is a windowed thread emerging on the surface of the security document 100 at spaced windows 95. Security articles such as item 90 can also be used to carry security devices of the sort now disclosed as will be described further below.

In this embodiment, the security document 100 is provided with a window region 80 which is transparent or translucent relative to the remainder of the document (i.e. it is at least semi-transparent). The construction by which this is achieved in the present embodiment is shown in FIG. 1(b) where it will be seen that the substrate 10 from which the security document 100 is formed has an opacifying layer 12(a), 12(b) on each surface thereof 10a, 10b which is omitted on both sides in the window region 80. The substrate 10 is a transparent or translucent substrate, preferably formed of polymer such as polypropylene (e.g. BOPP), polycarbonate or the like. Most preferably, the substrate is clear and colourless although as discussed below in some embodiments it may incorporate a coloured tint.

The substrate 10 could be monolithic or may be multi-layered, that is, made up of multiple layers of polymer laminated together. In this embodiment, the security device 1 is wholly applied to a first surface 10a of the substrate 10 but this is not essential and parts thereof may be applied to either the first side 10a or the second side 10b of the substrate 10 as will be discussed further below. Further, if the substrate 10 is a multi-layered substrate, all or part of the security device could be applied to internal layers of the substrate. It should also be noted that while the security device 1 is depicted as being applied directly on to the first surface 10a or the substrate, in practice, one or more intermediate layers may exist between the security device and the substrate 10, such as primer layers to aid adhesion of the security device 1.

The security device 1 in this example comprises two visible light emitting quantum dot compositions each applied to the substrate 10 in accordance with a respective sub-image 2a, 2b. Together, the sub-images 2a, 2b make up a photoluminescent image 2. In this example, the first sub-image 2a is an upward facing triangle and the second sub-image 2b is a downward facing triangle, with the “peaks” of the two triangular sub-images overlapping one another in the centre such that the resulting photoluminescent image 2 is in the shape of an hourglass. In this example, the security device 1 further includes a working of one or more non-luminescent conventional ink compositions 9 which may be used for example to provide additional detailing and/or colours which are not available from quantum dots (e.g. black).

The first sub-image 2a is formed of a first quantum dot composition 3a and the second sub-image 2b is formed of a different, second quantum dot composition 3b. Each quantum dot composition 3a, 3b could be applied continuously over the respective sub area 2a, 3b but more typically will be applied in accordance with a pixel array or a screened arrangement as depicted in the cross-section of FIG. 1(b). The sub-images may be half-toned as in conventional colour printing in order to convey variations of shade. Thus, in the portion of sub-image 2a which is not overlapped by sub-image 2b, only pixels of QD composition 3a will be present and in the portion of sub-image 2b which is not overlapped by sub-image 2a, only pixels of QD composition 3b will be present. Meanwhile in the central overlapping portion, pixels of both QD compositions 3a and 3b will be present alongside one another.

Under standard ambient lighting conditions (e.g. daylight), the photoluminescent image 2 may be invisible or could for example appear as a continuous, single-colour hourglass shape (with a periphery corresponding to the outline of the two overlapping sub-images 2a and 2b). This will depend on whether the QD compositions selected have any visible colour when the QDs are not activated. If the QD compositions 3a and 3b do each have a visible colour, it is preferred that these are selected so as to match one another under normal ambient lighting conditions (e.g. daylight). For example, when the QDs are not activated, both sets of compositions 3a and 3b may appear white or off-white. The concentration of the QDs in the two QD compositions 3a and 3b is preferably selected so that any low level emissions of light from the QDs under normal ambient lighting conditions (e.g. daylight) are concealed or overwhelmed by other light present and hence not noticeable to the naked human eye.

In this example, the first and second quantum dot compositions 3a and 3b are selected so as to have different emission spectra (λₑₘ), and excitation spectra (λₑₓ) which are the same or at least overlapping. Exemplary emission spectra and excitation spectra for both QD compositions 3a and 3b are shown in FIG. 1(c) which is a plot of intensity (in arbitrary units) against wavelength. It will be seen that the two QD compositions are both excited at wavelengths around 400 to 500 nanometres (i.e. in the deep blue to blue section of the spectrum). However, QD composition 3a when excited will emit at wavelengths in the green portion of the spectrum, whereas QD composition 3b when excited will emit wavelengths in the red portion of the spectrum.

To view the photoluminescent image 2 and thereby authenticate the security device 1, the security device is preferably illuminated in a transmissive mode as illustrated in FIG. 1(b), in which the security device is placed between the viewer O₁ and an appropriate light source L (which may in practice comprise multiple light sources). In this example, the light source L is configured to emit at least a wavelength λ₁, which as shown in FIG. 1(c) is in the blue part of the spectrum and falls within the overlapping portion of the two excitation spectra of compositions 3a and 3b respectively. Thus, such an illumination activates both of the QD compositions 3a and 3b with the result that the photoluminescent image 2 becomes visible. Now, the portion of first sub-image 2a which is not overlapped by second sub-image 2b will appear green, whilst that of second sub-image 2b which is not overlapped by first sub-image 2a will appear red. The central overlapping portion (2a+2b) will appear yellow, due to the additive mixing of the red and green emitting pixels both present in that area. It should be noted that such simultaneous activation of the first and second QD compositions 3a and 3b could also be achieved by illuminating the security device simultaneously with a wavelength falling inside the excitation spectrum of the first QD composition, and one falling inside that of the second QD composition, e.g. using a broadband light source L.

It should be noted that the security device could optionally also include one or more invisible light emitting QD compositions, i.e. those which emit only non-visible light (e.g. infrared or ultraviolet) when excited. The excitation spectra of such compositions may be arranged to also overlap the wavelength λ₁ of light source L, or could be configured to be excited at some other wavelength. The emitted light from such compositions will only be detectable by machine and will therefore not compromise the visible image.

FIG. 2 shows a second embodiment of a security device made according to the same principles and utilising the same first and second QD compositions as described in relation to the FIG. 1 embodiment. Again, the security device 1 comprises a photoluminescent image 2 arranged in a window 80 of a security document 100. In this example, the photoluminescent image 2 includes not only first and second photoluminescent sub-images 2a and 2b, each one formed of a respective quantum dot composition 3a, 3b, but also a void sub-image 4, in which no visible light emitting quantum dot composition is provided. The void sub-image in this case is formed by the absence of any QD composition, but in other examples could be formed by the provision of one or more QD compositions which emit invisible light only. Here, the photoluminescent image is generally circular, formed of two arcuate sections 2a and 2b which together enclose a central circular portion corresponding to the void sub-image 4. The void sub-image 4 can be used to display an additional colour to the viewer upon illumination which in this example will be the colour of the illuminating light itself since there is nothing to modify the visible colour of the incident light in the void sub-region 4. The QD compositions 3a, 3b have the same emission and excitation properties as shown in FIG. 1(c).

Thus, under ambient lighting conditions such as daylight, as in the case of the FIG. 1 example, the photoluminescent image 2 is either invisible or appears as a single-colour circular area with a hollow centre if the two compositions 3a and 3b have a matching visible colour. When the security device is illuminated with a predominantly blue light having a wavelength λ₁ (corresponding to that shown in FIG. 1(c)), the two QD compositions 3a and 3b will be activated such that the left half of the circle 2a now appears green and the right hand 2b is red. Meanwhile, the centre circle portion defined by void sub-region 4 appears blue.

It will be appreciated that whilst the FIG. 2 example has been explained using a simplistic graphic for clarity, the presence of all three colours red, green and blue enables the creation of complex full colour images and a further example of this will be shown below. Further, whilst in the example given the QD compositions used have had conventional Stokes shifts (i.e. they are excited by shorter wavelengths than those they emit), and hence the void sub-image 4 has been configured to correspond to the blue portion of the image, this is not essential. In other cases, the two QD compositions could provide any other two of the RGB channels (e.g. blue and green), and the void sub-image could provide the other (e.g. red).

Another way to create a full colour RGB image is to provide a security device with a third quantum dot composition of appropriate emitting colour, in a corresponding third luminescent sub-image. An example of this is shown in FIG. 3 which depicts a security device according to a third embodiment of the invention. In this example, the photoluminescent image 2 comprises three circular areas partially overlapping one another, corresponding to three sub-images 2a, 2b and 2c. First sub-image 2a is formed of first QD composition 3a, second sub-image 2b is formed of second QD composition 3b and third sub-image 2c is formed of third QD composition 3b. The first and second QD compositions 3a and 3b can be of the same types as already discussed in relation to FIGS. 1 and 2, the properties of which are illustrated in FIG. 1(c). The third QD composition 3c preferably has an excitation spectra in the region around 400 to 500 nanometres such that it at least partially overlaps those of both the first and second QD compositions 3a and 3b, and an emission spectrum which is also in the blue portion of the spectrum, such that upon excitation the third sub-region 2c appears blue.

On illumination with an appropriate light source L which excites all three quantum dot compositions 3a, 3b and 3c simultaneously, the complete photoluminescent image 2 becomes visible and exhibits the full range of RGB colours. Where the first and second sub-regions 2a and 2b overlap (only) the image will emit yellow light due to additive colour mixing, where the second and third sub regions 2b and 2c overlap (only), the image will emit magenta light due to additive colour mixing, and where the third and first sub-images 2c and 2a overlap (only) the image will emit cyan light, due to additive colour mixing. In the central portion of the device where all three sub-images overlap, the additive colour mixing will result in white light. Again, complex full colour images can now be formed, with any black portions thereof being provided either by regions of the image in which all three QD compositions are absent and/or by the provision of one or more conventional non-luminescent inks such as item 9 shown in FIG. 1.

An example of a more complex photoluminescent image 2 will now be illustrated with reference to FIG. 4, which depicts a security device 1 in accordance with a fourth embodiment of the invention. FIG. 4(a) shows in plan view the appearance of the photoluminescent image 2 when all of the QD compositions forming it are simultaneously activated. The result is a full colour portrait, preferably of photographic detail. For example, the portrait could be a passport photo showing the holder of the security document. In this example, the person's hair is yellow, shirt collar and jacket blue and cravat green. His face is depicted in various skin tones to convey contour and shading. The complete photoluminescent image 2 is formed in this example of two photoluminescent sub-images 2a and 2b and one void sub-image 4. The arrangement of pixels resulting from these overlapping sub-images is depicted purely schematically in the cross-section of FIG. 4(b). FIGS. 4(c)(i), (ii) and (iii) show the separate sub-images in plan view. The first sub-image 2a is shown in FIG. 4(c)(ii) and corresponds to the green channel of the image. Thus, the first QD composition 3a is laid down in pixels according to the sub-image 2a depicted (it should be noted that in the Figure, light portions of the sub-image 2a indicate a high intensity of the corresponding QD composition and dark portions thereof are low intensity). The second sub-image 2b, corresponding to the red channel of the image, is shown in Figure (c)(i). The second QD composition 3b will be applied in accordance with this sub-image 2b in a typical pixelated manner.

Finally, the third sub-image shown in FIG. 4(c)(iii) corresponds to the blue channel of the image and here is provided in the form of a void sub-image 4. That is, this sub-image is not itself printed or otherwise applied to the substrate 10, since it is defined by the absence rather than the presence of material. In practice, its area is defined between the bounds of the other sub-images 2a, 2b applied and, if necessary, a conventional non-luminescent ink may be applied in regions to assist in definition of the void sub-image 4. Thus, the first and second photoluminescent sub-images 2a and 2b are applied to substrate 10 leaving gaps defining void sub-image 4 to complete the photoluminescent image 2. Alternatively, the void sub-image 4 could be printed in an invisible light emitting QD composition. In this example, as in previous cases, all of the sub-images are shown applied to the same surface 10a of the substrate 10, but this is not essential.

For authentication, the security device could be viewed against a blue light of suitable wavelength which both activates the first and second QD compositions 3a and 3b as well as applies a blue colour to the void sub region 4 such that a full colour RGB plus white image is formed using the same principles as in the FIG. 2 embodiment. However, in a further preferred variant, an optical filter 8 is provided which is arranged in use between the photoluminescent image 2 and the light source L. The optical filter 8 transmits one or more wavelengths which collectively will enable activation of the first and second QD compositions 3a and 3b and give rise to the desired colour of the void sub region 4. Thus, in this example, the optical filter 8 preferably transmits blue light therethrough, including the wavelength λ₁. Now, authentication can be done using for example a white light source L such as a standard torch as may be found on a camera or mobile phone for example. Now, the activated first and second QD compositions 3a, 3b and the transmitted blue light in void sub region 4 will together produce the desired full colour photoluminescent image 2 for observer O₁.

More generally, it should be noted that an optical filter such as item 8 could be provided in embodiments of the invention with or without a void sub-image 4, in which case the visible colour of the light transmitted by the filter may not be a consideration, or may simply be used to suppress background light so as to render the emitted light from the QD compositions more clearly visible. While the optical filter 8 has been depicted as an additional layer applied to the second surface 10b of substrate 10 in the above embodiment, this is not essential and all that is required of the optical filter is that all of the QD compositions are arranged on the same side of it. For example, the optical filter could be located on the same surface of the substrate as the QD compositions (surface 10a in FIG. 4), between the QD compositions and the substrate. In other cases, the substrate 10 itself could act as the optical filter 8 if it contains a suitable filtering material such as a coloured tint. Alternatively if the substrate 10 is multi-layered, the optical filter 8 could be provided by or on one or more of its internal layers. The optical filter 8 could take the form of a printed or coated layer of suitable material, or could be an additional layer, film or foil applied to the structure.

As mentioned in connection with the FIG. 2 embodiment, whilst the use of blue illumination or a blue filter 8 is advantageous in that the majority of QD compositions require excitation by a shorter wavelength than they emit, this is not essential. More generally, the two QD compositions can provide any two of the three RGB colours, and the void sub-image can correspond to the third colour channel. For example, if one of the QD compositions has a standard Stokes shift and the other has an anti-Stokes shift, the two photoluminescent sub-images could correspond to the red and blue channels of the image while the void sub image corresponds to the green channel, in which either green illumination or a green optical filter would be used to view the complete image.

As noted above, the disclosed security devices 1 are suitable for authentication using a wide range of illumination sources L. However, a particularly preferred technique for performing authentication of such security devices will now be described with reference to FIG. 5. The method utilises a display screen as the light source L for performing authentication. Any form of display screen which emits light could be used, such as a backlit liquid crystal display, an LED display screen or a cathode ray tube display screen. Suitable widely available display screens include computer monitors (laptop, desktop or otherwise), TV screens and the screens of mobile devices such as mobile telephones and tablet computers. In FIG. 5, an exemplary mobile device 200 in the form of a now standard smartphone is shown, which has a display screen 201. The device 200 can be controlled by way of a suitable software programme or app configured for carrying out the following authentication procedure. To begin authentication, the user may open the correct app on their device, which may present them with a list of options as to the nature of the security document which is to be authenticated. For example, if the app is configured for authenticating British banknotes, the user could be presented with a menu of the existing denominations to select from. Alternatively, if the app is configured for authenticating passports or other ID documents, some information from the document may be input to the device (such as its serial number) which enables the device 200 to look up the relevant record for that specific document on a database, and optionally to retrieve information as to how the security device 1 on that document should appear.

The device 200 would then be controlled by the program or app to display a user interface such as that shown in FIG. 5(a) which includes an illumination area 205. The illumination area 205 could occupy the entire screen 201 or, optionally, additional features may be provided outside area 205 as illustrated in this example. Thus, beside area 205 a region 210 may be provided for displaying therein a computer-generated copy 211 of the photoluminescent image 2 which the selected security document 100 should reveal on authentication. The screen may also display an indicator 212 identifying the security document in question. The illumination area 205 could be of any size but is preferably large enough such that the whole of the security device 1 can be comfortably accommodated within it.

The illumination area 205 is then controlled to display the desired illumination wavelength such as λ₁ which here is blue. The particular wavelength or waveband to be displayed in this region will of course need to be selected in dependence on the nature of the QD compositions carried by the security document 100 in question. Thus, the app may contain or have access to a database of the relevant security documents and corresponding illumination wavelengths that should be used for each one. When the user wishes to carry out authentication, as shown in FIG. 5(b), they place the security document 100 over the display screen 201 of device 200 in such a way that the security device 1 is positioned between the display screen 201 and the viewer, within the region of illumination area 205. The security device 1 is thus illuminated in a transmissive mode by the illumination area 205 and the photoluminescent image 2 is activated. The user is thus able to note the presence of the photoluminescent image 2 and confirm the authenticity of the security document 100. To aid authentication, as noted above, the display screen 201 may optionally show alongside the illumination area 205 a computer generated image 211 of how the photoluminescent image 2 should appear, reproducing not only the outline but also its colours. This enables the user to quickly compare the two and judge whether the security device 1 is authentic.

In all of the embodiments described so far, the QD compositions utilised have had different emission spectra from one another but substantially the same excitation spectra (although this has not been essential since multiple illumination wavelengths could be used simultaneously in the above embodiments to activate the image 2 if necessary). In other embodiments of the invention, as will now be described, it is the excitation spectra of the various QD compositions which must differ from one another whereas the emission spectra can be the same. An example of this will be described in relation to FIG. 6 which depicts a fifth embodiment of a security device in accordance with the present invention. Once again, FIG. 6(a) shows the security device 1 in plan view, and 6(b) in cross-section along the line Q-Q′. In this case, it will be noted from FIG. 6(b) that the substrate 10′ on which the security device 1 is arranged need not be transparent or translucent, and could for example be opaque. For instance, the substrate 10′ could be an opacified polymer substrate or could be a conventional fibre substrate such as paper or cardboard. Nonetheless, transparent substrates and arrangements such as those shown in the previous Figures can also be used. In the arrangement shown, the security device 1 will be viewed by an observer O₁ under reflected light from a source L.

In this embodiment, the photoluminescent image 2 is configured as a set of frames which when viewed in sequence reveal an animation effect. Thus, the image 2 is not designed to be viewed with all of its sub-images activated simultaneously, but rather only one or a subset thereof at a time. Of course, it is possible to activate all of the sub-images at once but then the image may appear unintelligible. In the present example, the image 2 is made up of four sub-images 2a, 2b, 2c and 2d, each of which is formed by a corresponding QD composition 3a, 3b, 3c and 3d. Each sub-image 2a, 2b, 2c and 2d takes the form of a chevron and the four chevrons are positioned adjacent to one another along the X direction.

FIG. 6(c) is a plot illustrating the excitation spectra λₑₓ and emission spectra λₑₘ of the four QD compositions 3a, 3b, 3c and 3d. It will be seen that each of the four QD compositions has a different excitation spectra with peak excitation wavelengths λ₁, λ₂, λ₃ and λ₄ respectively. Meanwhile, all four QD compositions have substantially the same emission spectra, which lie in the red portion of the spectra. It will be noted that a single emission spectrum has been shown in this location, which represents that of each of the four QD compositions. Of course, in practice, there may be some differences between the emission spectra of the four compositions but in this embodiment it is preferred that all emit substantially the same visible colour (here, red—although the specific hue might vary).

To authenticate the security device, the four QD compositions 3a, 3b, 3c and 3d are activated sequentially by appropriate illumination wavelengths. Thus, as illustrated in FIGS. 6(d)(i), (ii), (iii) and (iv), in a first illumination step the security device 1 is illuminated with a wavelength around λ₁, which activates only the first QD composition 3a and none of the others. Under this illumination condition, as shown in FIG. 6(d)(i), the chevron formed by first sub-image 2a is activated and appears red. In the next illumination step, the security device 1 is illuminated with a second wavelength λ₂. This activates only the second QD composition 3b and none of the others. As shown in FIG. 6(d)(ii), now only the chevron corresponding to second sub-image 2b is activated and appears red. In a third illumination step, a third wavelength λ₃ is used to activate only third sub region 2c, as shown in FIG. 6(d)(iii), and in a fourth illumination step, a fourth wavelength λ₄ is used to activate the fourth sub-image 2d as shown in FIG. 6(d)(iv). Thus, as the sequence of illumination steps progresses, the security device 1 appears to display a red chevron shape which moves in the X direction across the device. Of course, the order of illumination steps could be changed, e.g. if performed in the reverse order, the sub-images would be activated from right to left across the device instead, and the chevron would appear to move backwards, in the −X direction. It would also be possible to perform the illumination steps in any random sequence in which case the chevron may appear to jump from one position to another.

Also possible is to include intermediate illumination steps between any of the illumination steps already mentioned. In the intermediate illumination steps, two or more of the excitation wavelengths λ₁, λ₂, λ₃ and λ₄ may be used simultaneously to illuminate the device to thereby activate two or more of the sub-images. For example, between the steps of activating first sub-image 2a and then second sub-image 2b, it may be desirable to activate both of them to achieve a smoother animation effect.

FIG. 7 depicts a sixth embodiment of a security device in accordance with the present invention which also exhibits an animation effect upon sequential illumination. The security device 1 is shown in plan view in FIG. 7(a) and in cross-section in FIG. 7(b) along the line Q-Q′ shown in FIG. 7(a). In this case, the security device 1 is provided on a transparent substrate 10 in the same manner as the first to fourth embodiments, but this is not essential. In this example, the photoluminescent image 2 comprises three luminescent sub-images 2a, 2b and 2c which again are configured as a set of frames which when viewed in sequence will produce an animation effect. The first sub-image 2a is in the shape of a sun symbol, the second sub-image 2b in the shape of a star and the third sub-image 2c in the shape of a crescent moon. As in previous embodiments, the first sub-image 2a defines the area within which pixels of the first QD composition 3a are present, the second sub-image 2b defines the area within which pixels of the second QD composition 3b are present and the third sub-image 2c defines the area within which pixels of the third QD composition 3c are present. In regions where the sub-images overlap, pixels of two or more of the QD compositions will be present.

FIG. 7(c) is a plot illustrating the excitation and emission spectra of the three QD compositions 3(a), 3(b) and 3(c). In this example, the excitation spectra λₑₓ of the three QD compositions are different from one another and the emission spectra λₑₘ of the three QD compositions are different from one another. Thus, not only will the different sub-images be excited by different illumination wavelengths, but they will also appear with different colours once excited. In this example, the first QD composition 3a has an excitation spectrum in the near UV, the second QD composition 3b has an excitation spectrum in the deep blue and the third QD composition 3c has an excitation spectrum in the blue region of the visible spectrum. Whilst the excitation spectra of the respective QD compositions may overlap to some extent, it is desirable at least a portion of each excitation spectrum is not overlapped by any of the others so that wavelengths can be identified which will each activate only one of the compositions, such as wavelengths λ₁, λ₂ and λ₃ identified in the Figure. The first QD composition 3a has an emission spectrum in the blue part of the spectrum and will therefore appear blue on activation, the second QD composition 3b has an emission spectrum in the green part of the visible spectrum and hence it will appear green on activation and the third QD composition 3c has an emission spectrum in the red portion of the visible spectrum and hence will appear red on activation.

To authenticate the device, the photoluminescent image 2 is sequentially illuminated, preferably in a transmissive illumination mode, with a series of sequential illumination steps similar to that described with reference to FIG. 6. Thus in a first illumination step, the security device 1 is illuminated at a first wavelength λ₁ which activates the first sub-image 2a, which appears as a blue coloured sun shaped symbol as shown in FIG. 7(d)(i). In the next illumination step the security device 1 is illuminated with a second wavelength λ₂ which now activates only the second sub-image 2b and thus the image 2 appears as shown in FIG. 7(d)(ii) as a green star. In a third illumination step, the security device 1 is illuminated at a third wavelength λ₃ which activates only the third sub-image 2c and thus the security device appears as a crescent moon in the colour red. As the sequence of illumination steps progresses, the security device will therefore appear to show a switching effect, changing between the sun, star and moon shapes illustrated in FIG. 7(d). Of course, if desired, a greater number of frames may be provided, each in a respective different QD composition, and if so configured could be arranged to provide a smoother change from one shape symbol to the next, thus giving rise to a morphing effect. It is also possible to provide many other forms of animation effect such as a zooming or contracting effect or the rotation of a 3D object, through appropriate configuration of each sub-image.

Again, any suitable illumination means could be used to perform the authentication. However, apparatus such that already discussed with reference to FIG. 5(a) is particularly suitable, and FIG. 8 shows how this can be adapted for use with security devices of the sort described with reference to FIGS. 6 and 7. Thus in FIGS. 8(a) and 8(b), a device 200 is shown which has already been described with reference to FIG. 5 and hence will not be described again. However, in this mode of authentication, which might be selected through selection of the security document in question as indicated by indicator 212, the illumination area 205 no longer displays a static wavelength or colour, but now displays a sequence of different wavelengths one after the other, in order to sequentially activate the respective sub-images as described in relation to FIGS. 6 and 7. In FIG. 8(a), a first illumination step is depicted with the user holding the security document 100 against the display screen 201 of the device 200. The illumination area is emitting a first wavelength λ₁ of light which activates a first sub-image of the security device 1 which in this example is a pound sign (“£”). As before, the device may optionally display a computer generated image 211 of the same image for easy comparison. In the next illumination step, as shown in FIG. 8(b), the illumination region 205 switches to emitting a second wavelength of light λ₂. This causes the security device to stop displaying the pound sign and switch to displaying the second sub-image, which here is the digit “20”. At the same time as switching from the first wavelength λ₁ to the second wavelength λ₂, in the illumination area 205, the computer generated image 211 may also switch to show a copy of the newly expected appearance of the security device. The duration of each illumination step and the point at which the emitted wavelength is switched from λ₁ to λ₂ may be controlled by programming of the device and/or by the user; for example the user may press a button on the device 200 in order to advance to the next illumination step. The device 200 may be controlled to alternately switch between the two illumination steps so that the appearance of the device switches repeatedly between the pound sign and the digit 20. Again, if displayed, the computer generated version of the image 211 should switch in a corresponding manner.

In the FIG. 8 example, the photoluminescent image illustrated includes a symbol and alphanumeric text which in this case will be common to all of the security documents on banknotes of the same series. However, as mentioned above the present invention lends itself well to providing a unique identifier or personalised information, and so in other examples the photoluminescent image could comprise other alphanumeric data, such as a serial number, the document holder's name or date of birth, etc. More generally the image 2 can comprise any graphic, symbol, alphanumeric text, logo, photo or the like.

It should be noted that any of the embodiments of FIG. 6, 7 or 8 could include a void sub-image 4 and/or an optical filter 8 and/or additional contributions from non-luminescent ink 9, as described in earlier embodiments.

A seventh embodiment of the invention will be described with reference to FIG. 9. In this case the security device 1 has the appearance of a full colour, animated image, which here takes the form of a portrait (e.g. a passport photo). As shown in FIG. 9(b), the security device 1 is arranged in a window region 80 on a security document which has a transparent substrate 10 carrying opacifying layers 12(a), 12(b) on either side as already described with reference to FIG. 1. In this case, a first part of the security device 1 is arranged on a first surface 10a of the substrate 10 and a second part of the security device is arranged on the second surface 10b of the substrate 10. FIG. 9(a) shows the appearance of the security device in plan view under a first illumination condition, and FIG. 9(c) shows the same security device also in plan view under a second illumination condition. It should be noted that both of these appearances are viewed from the same side of the security device but under different illumination. Thus it is not the case that one represents the front view and the other the reverse view of the device.

On the first surface 10a of the substrate 10, three sub-images 2a, 2b and 2c are provided, which collectively form a first frame 5a. Each of the sub-images is provided in a different QD composition 3a, 3b, 3c, the emitted colour of which corresponds to the desired colour of that sub-image. In the first frame 5a, the image formed by the three sub-images 2a, 2b, 2c in combination is that of a person looking to the left. On the second surface 10b of substrate 10, another three sub-images 2d, 2e and 2f are provided which form a second frame 5b. Again, each of the sub-images 2d, 2e and 2f is provided by a corresponding QD composition 3d, 3e and 3f. The second frame 5b is also a full colour portrait of the same subject as that of the first frame 5a but now looking to the right. It should be noted that whilst for convenience all of the sub-images forming first frame 5a have been provided on one surface of substrate 10 and all of the sub-images forming second frame 5b have been provided on the other surface of substrate 10, this is not essential. For instance, the sub-images making up frame 5a could be provided on both the top and bottom surfaces of the substrate and likewise so could those making up the second frame 5b. It is also possible to utilise internal layers within the substrate 10 where this is a multi-layer structure.

FIG. 9(d) illustrates the excitation and emission spectra λₑₓ, λₑₘ of the six QD compositions 3a to 3f used to form the security device 1. FIG. 9(d)(i) shows the three sub-images 2a, 2b and c which make up first frame 5a. Each of these QD compositions 3a, 3b and 3c have an excitation spectra in the deep blue and can be activated by an illumination wavelength λ₁. Their emission spectra sit in the blue, green and red regions of the visible spectrum respectively and hence when all of the QD compositions 3a, 3b and 3c are illuminated by wavelength λ₁ will combine to exhibit a full colour image as shown in FIG. 9(a).

FIG. 9(d)(ii) shows the three sub-images 2d, 2e and 2f making up second frame 5b of the image 2, and again each is formed by a corresponding QD composition 3d, 3e and 3f. Each of these three compositions has an excitation spectrum in the blue portion of the visible spectrum and can be activated by illumination wavelength λ₂. Again, the corresponding emission spectra lie in the blue, green and red portions of the visible spectrum and hence when these three compositions are activated by an illumination wavelength λ₂, a full colour image will be exhibited as shown in FIG. 9(c).

It will be appreciated that in this embodiment it is desirable at least for the compositions 3a, 3b and 3c to be invisible when the quantum dots contained therein are not activated, so as not to obscure the view of the underlying frame 5b. To avoid this problem it is also possible to arrange both frames 5a, 5b to be located on the same surface of substrate 10 (e.g. in an interlaced form) provided a sufficiently high resolution application technique is available.

Again, the security device shown in FIG. 9 can be authenticated using any appropriate illumination source. However, the device already described with reference to FIG. 5(a) is particularly suitable for this purpose and FIG. 10 shows the use of such in authenticating the FIG. 9 device. Thus, in use the user would select the appropriate security document as indicated at 212 and place the security document 100 against the display screen 201 of the device 200. As shown in FIG. 10, in a first illumination step the illumination area 205 will emit a first illumination wavelength λ₁ which activates all of the sub-images of the first frame 5a and not those of the second frame 5b. Thus, the security device exhibits the full colour portrait looking to the left. In a second illumination step, the illumination wavelength switches to λ₂ and now the sub-images making up second frame 5b are activated whilst those making up first frame 5a are not. As such, the appearance of the security device appears to switch with the full colour image portrait looking to the right. Additional frames could be provided by extending the same principles explained above, to create smoother animation effects if desired.

It will be appreciated that in the present embodiment it will be desirable for the emitted colours of the six quantum dot compositions 3a to 3f to be closely paired so that, for example, the compositions 3a and 3d emit substantially the same blue hue on activation, the compositions 3b and 3e emit substantially the same green hue on activation and the compositions 3c and 3f emit substantially the same red hue on activation. However, some variation here is acceptable and may be accounted for through the configuration of the respective sub-images.

Whilst the various authentication methods utilising multiple illumination wavelengths have only been described with reference to the use of two illumination steps, it should be appreciated that any number of illumination steps could be implemented in sequence through appropriate control of the device 200 or other illumination source.

Security devices of the sorts described above can be incorporated into or applied to any item for which an authenticity check is desirable. In particular, such devices may be applied to or incorporated into documents of value such as banknotes, passports, driving licenses, cheques, identification cards etc.

The security device or article (Le, an element such as a thread or foil carrying the security device) can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travellers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP-A-0059056. EP-A-0860298 and WO-A-03095188 describe different approaches for the embedding of wider partially exposed threads into a paper substrate. Wide threads, typically having a width of 2 to 6 mm, are particularly useful as the additional exposed thread surface area allows for better use of devices such as that presently disclosed.

The security device or article may be subsequently incorporated into a paper or polymer base substrate so that it is viewable from both sides of the finished security substrate. Methods of incorporating security elements in such a manner are described in EP-A-1141480 and WO-A-03054297. In the method described in EP-A-1141480, one side of the security element is wholly exposed at one surface of the substrate in which it is partially embedded, and partially exposed in windows at the other surface of the substrate.

Base substrates suitable for making security substrates for security documents may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security device or a separate security device can be applied to the transparent substrate of the document. WO-A-0039391 describes a method of making a transparent region in a paper substrate. Other methods for forming transparent regions in paper substrates are described in EP-A-723501, EP-A-724519, WO-A-03054297 and ER-A-1398174.

The security device may also be applied to one side of a paper substrate so that portions are located in an aperture formed in the paper substrate. An example of a method of producing such an aperture can be found in WO-A-03054297. An alternative method of incorporating a security element which is visible in apertures in one side of a paper substrate and wholly exposed on the other side of the paper substrate can be found in WO-A-2000/39391.

Examples of such security document and techniques for incorporating a security device will now be described with reference to FIGS. 11 to 14.

FIG. 11 depicts an exemplary document of value 100, here in the form of a banknote. FIG. 11a shows the banknote in plan view whilst FIG. 11b shows the same banknote in cross-section along the line Q-Q′. In this case, the banknote is a polymer (or hybrid polymer/paper) banknote, having a transparent substrate 10 (corresponding to that shown in FIG. 1(b)). Two opacifying layers 12a and 12b are applied to either side of the transparent substrate 10, which may take the form of opacifying coatings such as white ink, or could be paper layers laminated to the substrate 10.

The opacifying layers 12a and 12b are omitted across an area 80 which forms a window within which the security device 1 is located. As shown best in the cross-section of FIG. 11b, the security device 1 is arranged on one surface of the substrate 10 although as mentioned above it could be located partly on one surface and partly on the other. In this example the photoluminescent image is of the letters “ABC” which may be provided in different respective QD compositions. It should be noted that in modifications of this embodiment the window 80 could be a half-window with the opacifying layer 12b continuing across all or part of the window over the security device 1. In this case, the window will not be transparent but will still appear relatively translucent compared to its surroundings. Half-windows are less preferred since the opacifying layer will typically introduce a scattering effect which may reduce the intensity of illumination received by the QD compositions if illuminated in a transmissive mode. However acceptable results may still be achievable depending on the desired design. The banknote may also comprise a series of windows or half-windows. In this case the security device could be configured to display different images in different ones of the windows.

FIG. 12 shows such an example, although here the banknote 100 is a conventional paper-based banknote provided with a security article 105 in the form of a security thread (similar to item 90 in FIG. 1), which is inserted during paper-making such that it is partially embedded into the paper so that portions of the paper 104 lie on either side of the thread. This can be done using the techniques described in EP0059056 where paper is not formed in the window regions during the paper making process thus exposing the security thread in is incorporated between layers of the paper. The security thread 105 is exposed in window regions 81 of the banknote. Alternatively the window regions 81 which may for example be formed by abrading the surface of the paper in these regions after insertion of the thread. The security device 1 is formed on the thread 105, which comprises a transparent substrate, with the QD compositions located on one or both of its surfaces. In the version shown, the thread 105 only emerges to the surface on one side of the paper such that the window regions 81 are half window regions. However, techniques exist for forming the apertures on both sides of the thread 105 so that the windows 81 are full windows, which is preferred.

If desired, several different security devices 1 could be arranged along the thread, with different or identical images displayed by each. In one example, a first window could contain a first device, and a second window could contain a second device, each having the same or different combinations of OD compositions. In the example shown, the device collectively exhibits the letters “X, Y, Z”, one in each window, which are preferably each formed of different QD compositions.

In FIG. 13, the banknote 100 is again a conventional paper-based banknote, provided with a strip element or insert 108. The strip 108 is based on a transparent substrate and is inserted between two plies of paper 109a and 109b. The security device 1 is disposed on one side of the strip substrate, although could be on both sides as previously discussed. The paper plies 109a and 109b are apertured across region 82 to reveal the security device 1, which in this case may be present across the whole of the strip 108 or could be localised within the aperture region 101.

A further embodiment is shown in FIG. 14 where FIGS. 14(a) and (b) show the front and rear sides of the document 100 respectively, and FIG. 14(c) is a cross section along line Q-Q′. Security article 110 is a strip or band comprising a security device 1 according to any of the embodiments described above. The security article 110 is formed into a security document 100 comprising a fibrous substrate 102, using a method described in EP-A-1141480. The strip is incorporated into the security document such that it is fully exposed on one side of the document (FIG. 14(a)) and exposed in one or more windows 83 on the opposite side of the document (FIG. 14(b)). Again, the security device 1 is formed on the strip 110, which comprises a transparent substrate.

In FIG. 14, the document of value 100 is again a conventional paper-based banknote and again includes a strip element 110. In this case there is a single ply of paper. Alternatively a similar construction can be achieved by providing paper 102 with an aperture 83 and adhering the strip element 110 on to one side of the paper 102 across the aperture 83. The aperture may be formed during papermaking or after papermaking for example by die-cutting or laser cutting. Again, the security device is formed on the strip 110, which comprises a transparent substrate.

The security device of the current invention can be made machine readable by the introduction of additional detectable materials in any of the components or by the introduction of separate machine-readable layers. Additional detectable materials that react to an external stimulus include but are not limited to infrared absorbing, thermochromic, photochromic, magnetic, electrochromic, conductive and piezochromic materials.

When a magnetic material is incorporated into the device the magnetic material can be applied in any design but common examples include the use of magnetic tramlines or the use of magnetic blocks to form a coded structure. Suitable magnetic materials include iron oxide pigments (Fe₂O₃ or Fe₃O₄), barium or strontium ferrites, iron, nickel, cobalt and alloys of these. In this context the term “alloy” includes materials such as Nickel:Cobalt, Iron:Aluminium:Nickel:Cobalt and the like. Flake Nickel materials can be used; in addition Iron flake materials are suitable. Typical nickel flakes have lateral dimensions in the range 5-50 microns and a thickness less than 2 microns. Typical iron flakes have lateral dimensions in the range 10-30 microns and a thickness less than 2 microns.

In an alternative machine-readable embodiment a transparent magnetic layer can be incorporated at any position within the device structure. Suitable transparent magnetic layers containing a distribution of particles of a magnetic material of a size and distributed in a concentration at which the magnetic layer remains transparent are described in WO03091953 and WO03091952.

1-65. (canceled)

66. A security device comprising:
a substrate; and
a photoluminescent image disposed on or in the substrate, the photoluminescent image comprising at least two different visible light emitting photoluminescent quantum dot compositions, each arranged according to different respective photoluminescent sub-images, the at least two different visible light emitting photoluminescent quantum dot compositions having different emission spectra from one another, and the same or different excitation spectra, the at least two different visible light emitting photoluminescent quantum dot compositions thereby emitting different respective visible colours from one another when excited;
wherein the respective photoluminescent sub-images are configured such that the photoluminescent image formed by the combination of the respective photoluminescent sub-images is multi-coloured, emitting different visible colours in different laterally offset parts thereof upon excitation of the at least two different visible light emitting photoluminescent quantum dot compositions;
wherein at least a portion of the photoluminescent image overlaps an at least semi-transparent region of the substrate.

67. The security device according to claim 66, wherein the photoluminescent image further comprises a void sub-image in which no visible light emitting photoluminescent quantum dot composition is provided, the void sub-image being defined by and between the at least two different visible light emitting photoluminescent quantum dot compositions.

68. The security device according to claim 67, wherein the at least two different visible light emitting photoluminescent quantum dot compositions include a first photoluminescent quantum dot composition which emits one of red, green or blue light when excited and a second photoluminescent quantum dot composition which emits a different one of red, green or blue light when excited, and the void sub-image corresponds to those parts of the photoluminescent image which require the third one of red, green or blue light, not emitted by either the first or second quantum dot composition.

69. The security device according to claim 68, wherein the first photoluminescent quantum dot composition emits red light when excited, the second photo luminescent quantum dot composition emits green light when excited, and the void sub-image corresponds to parts of the photoluminescent image which require blue light.

70. The security device according to claim 66, further comprising:
an optical filter which selectively transmits light of a waveband which excites one or more of the at least two different visible light emitting photoluminescent quantum dot compositions, and wherein the photoluminescent sub-images are arranged such that all of the photoluminescent quantum dot compositions are provided on a first side of the optical filter and at least part of the photoluminescent image overlaps the optical filter.

71. The security device according to claim 70, wherein the visible colour of the waveband of light selectively transmitted by the optical filter is different from each of the visible colours of the at least two different visible light emitting photoluminescent quantum dot compositions when excited.

72. The security device according to claim 69, wherein the visible colour of the wavelength of light selectively transmitted by the optical filter is blue.

73. The security device according to claim 66 further comprising at least one invisible light emitting photoluminescent quantum dot composition.

74. A method of manufacturing a security device, comprising
forming a photoluminescent image on or in a substrate, by applying at least two different visible light emitting photoluminescent quantum dot compositions, each arranged according to different respective photoluminescent sub-images, the at least two different visible light emitting photoluminescent quantum dot compositions having different emission spectra from one another, and the same or different excitation spectra, the at least two different visible light emitting photoluminescent quantum dot compositions thereby emitting different respective visible colours from one another when excited;
wherein the respective photoluminescent sub-images are configured such that the photoluminescent image formed by the combination of the respective photoluminescent sub-images is multi-coloured, emitting different visible colours in different laterally offset parts thereof upon excitation of the at least two different visible light emitting photoluminescent quantum dot compositions;
wherein at least a portion of the photoluminescent image overlaps an at least semi-transparent region of the substrate.

75. The method of manufacturing a security device according to claim 74,
further comprising applying at least one invisible light emitting photoluminescent quantum dot composition.

76. The method of authenticating a security device according to claim 66; wherein the at least two visible light emitting photoluminescent quantum dot compositions include:
a first photoluminescent quantum dot composition having a first excitation spectra and a first emission spectra; and
a second photoluminescent quantum dot composition having a second excitation spectra and a second emission spectra;
the method comprising:
illuminating the photoluminescent image with light of the first excitation spectra and of the second excitation spectra such that the security device exhibits the photoluminescent sub-images of the first and second photoluminescent quantum dot compositions simultaneously.

77. The method according to claim 76, wherein illuminating the photoluminescent image comprises:
positioning the security device between a viewer and a light source emitting light of the first excitation spectra and of the second excitation spectra, such that the portion of the photoluminescent image which overlaps the at least semi-transparent region of the security device is either: illuminated through the at least semi-transparent region; or is visible to the viewer through the at semi-transparent region.

78. The method according to claim 76, wherein the photoluminescent image further comprises a void sub-image in which no visible light emitting photoluminescent quantum dot composition is provided, the void sub-image being defined by and between the at least two different visible light emitting photoluminescent quantum dot compositions, such that when the photoluminescent image is illuminated with light the void sub-image reflects and/or transmits at least one or more wavelengths of the illuminating light.

79. The method according to claim 78, wherein the visible colours emitted by the visible light emitting photoluminescent quantum dot compositions and that of the at least one or more wavelengths of the illuminating light reflected or transmitted by the void sub-image are selected such that when illuminated, the photoluminescent image exhibited by the security device is a full colour image formed by the photoluminescent sub-images and the void sub-image.

80. The method according to claim 79, wherein the void sub-image reflects and/or transmits all visible wavelengths of the illuminating light, the first photoluminescent quantum dot composition emits one of red, green or blue light when excited and the second photoluminescent quantum dot composition emits a different one of red, green or blue light when excited, and the void sub-image corresponds to those parts of the photoluminescent image which require the third one of red, green or blue light, not emitted by either the first or second quantum dot composition, and wherein the illuminating light is the third one of red, green or blue light, not emitted by either the first or second quantum dot composition.

81. The method according to claim 76, wherein the security device further comprises an optical filter which selectively transmits light of a waveband which excites one or more of the at least two photoluminescent quantum dot compositions, the photoluminescent sub-images being arranged such that all of the photoluminescent quantum dot compositions are provided on a first side of the optical filter and at least part of the photoluminescent image overlaps the optical filter, and wherein illuminating the photoluminescent image comprises positioning the security device between the viewer and a light source such that the optical filter is between the photoluminescent quantum dot compositions and the light source.

82. The method according to claim 78, wherein the at least one wavelength of the illuminating light transmitted by the void sub-image corresponds to the waveband transmitted by the optical filter, the first photoluminescent quantum dot composition emits one of red, green or blue light when excited and the second photoluminescent quantum dot composition emits a different one of red, green or blue light when excited, and the void sub-image corresponds to those parts of the photoluminescent image which require the third one of red, green or blue light, not emitted by either the first or second quantum dot composition, and wherein the visible colour of the waveband transmitted by the optical filter is the third one of red, green or blue light, not emitted by either the first or second quantum dot composition.

83. The method according to claim 77, wherein the light source comprises a display screen configured to emit light of the first excitation spectra and of the second excitation spectra across an area corresponding to all or part of the photoluminescent image.

84. A security device comprising:
a substrate; and
a photoluminescent image disposed on or in the substrate, the photoluminescent image comprising at least two different visible light emitting photoluminescent quantum dot compositions, each arranged according to different respective photoluminescent sub-images, the at least two different visible light emitting photoluminescent quantum dot compositions having different excitation spectra from one another, and the same or different emission spectra;
wherein the respective photoluminescent sub-images are each configured to define a different one of a set of image frames which, when excited sequentially, exhibit the photoluminescent image, which is animated.

85. The security device according to claim 84, wherein the at least two different visible light emitting photoluminescent quantum dot compositions have different emission spectra from one another, the at least two different visible light emitting photoluminescent quantum dot compositions thereby emitting different respective visible colours from one another when excited, whereby the animated photoluminescent image is multi-coloured.

86. The security device according to claim 84 further comprising at least one invisible light emitting photoluminescent quantum dot composition.

87. A method of authenticating a security device, the security device comprising:
a substrate; and
a photoluminescent image disposed on or in the substrate, the photoluminescent image comprising at least two different visible light emitting photoluminescent quantum dot compositions, each arranged according to different respective photoluminescent sub-images, the at least two different visible light emitting photoluminescent quantum dot compositions having the same or different emission spectra from one another, and different excitation spectra;
the method comprising the steps of:
sequentially illuminating the photoluminescent image with light of different wavelengths, such that the at least two different visible light emitting photoluminescent quantum dot compositions are excited sequentially and the security device exhibits the photoluminescent sub-images sequentially.

88. The method according to claim 87, wherein sequentially illuminating the photoluminescent image comprises:
illuminating the photoluminescent image with light at a first wavelength, wherein the first wavelength is within the excitation spectra of a first photoluminescent quantum dot composition of the at least two visible light emitting photoluminescent quantum dot compositions but not within the excitation spectra of a second photoluminescent quantum dot composition of the at least two visible light emitting photoluminescent quantum dot compositions, such that the security device exhibits a first photoluminescent sub-image; and then
illuminating the photoluminescent image with light at a second wavelength, wherein the second wavelength is within the excitation spectra of the second photoluminescent quantum dot composition but not within the excitation spectra of the first photoluminescent quantum dot composition, such that the security device exhibits a second photoluminescent sub-image.

89. The method according to claim 88, wherein the steps of illuminating the photoluminescent image with light at the first wavelength and illuminating the photoluminescent image with light at the second wavelength are performed alternately or periodically.

90. The method according to claim 87, wherein the photoluminescent sub-images are each configured to define a different one of a set of image frames which, when
excited sequentially, exhibit the photoluminescent image, which is animated.
